(19) United States
(12) Patent Application Publication
(10) Pub. No.: US 2012/0162381 A1
(43) Pub. Date: Jun. 28, 2012

(54) IMAGE PROCESSING APPARATUS, CONTROL METHOD THEREOF, AND PROGRAM

(75) Inventors: Shuuji Okegawa, Chiba (JP); Takahiro Tokuda, Tokyo (JP); Hirokazu Nakaya, Saitama (JP)

(73) Assignee: Sony Corporation, Tokyo (JP)

(21) Appl. No.: 13/329,815

(22) Filed: Dec. 19, 2011

(30) Foreign Application Priority Data
Dec. 28, 2010 (JP) P2010-292027

(51) Int. Cl. H04N 13/02

(52) U.S. Cl. 348/47; 348/E13.074

(57) ABSTRACT

An image processing apparatus includes a posture detection unit detecting a posture of the image processing apparatus, an image capturing unit generating a planar image including a subject or a stereoscopic image for stereoscopy of the subject, a mode setting unit setting any one of a planar image capturing mode and a stereoscopic image capturing mode, an image conversion unit converting the image through performing of aspect conversion and reduction processes, and a control unit operating to record the stereoscopic image on a recording medium regardless of the detected posture of the image processing apparatus if the stereoscopic image capturing mode is set and to record any one of the planar image and a converted image obtained by converting the planar image on the recording medium on the basis of the detected posture of the image processing apparatus if the planar image capturing mode is set.

### CROSS-REFERENCE TO RELATED APPLICATION

The present application claims priority from Japanese Patent Application No. JP 2010-292027 filed in the Japanese Patent Office on Dec. 28, 2010, the entire content of which is incorporated herein by reference.

### BACKGROUND

The present disclosure relates to an image processing apparatus, and more particularly to an image processing apparatus that treats a stereoscopic image, a control method thereof, and a program causing a computer to execute the corresponding method.

Recently, an image capturing device, such as a digital still camera or a digital video camera (for example, an integrated camera recorder), which captures a subject such as a person or the like, generates a captured image (image data), and records the generated captured image as image content (image file), has been widespread. For example, in such an image capturing device, the generated captured image is recorded in a recording medium using a predetermined recording format.

Here, in a recording format that is used in recording a captured image, an aspect ratio may be determined. For example, in the case of a moving image recording format, 16:9 (=width: length) or 4:3 (=width:length) may be determined as an aspect ratio. Recently, a technique that treats such an aspect ratio has been developed.

For example, an image signal processing apparatus that compares plural kinds of aspect ratios with each other and outputs an image with an optimum aspect ratio has been proposed (for example, see Japanese Unexamined Patent Application Publication No. 2009-3240).

### SUMMARY

According to the above-described related art, the aspect ratio may be optimized between images having horizontally long aspect ratios.

Here, during an image capturing operation, an image capturing device may not be put in a certain posture. Due to this, it is assumed that according to the posture of the image capturing device, the upper and lower sides of a subject may be different from the upper and lower sides of a user (viewer) (for example, the posture of the subject may be reversed or the subject may be lying on its side). Accordingly, by performing an image conversion process in consideration of the posture of the image capturing device during the image capturing, an image can be displayed so that the upper and lower sides of the subject and the upper and lower sides of the user (viewer) during image reproduction have a proper relationship.

Here, it is assumed that a recording process or a display process is performed with respect to a stereoscopic image. Since the stereoscopic image obtains stereoscopic vision using parallax of left and right eyes, for example, the subjects included in a left-eye image and a right-eye image are shifted from each other in a horizontal direction. Due to this, in the case of seeing a stereoscopic image (a left-eye image and a right-eye image), it is necessary for a user (viewer) to see the displayed stereoscopic image in a predetermined position and posture. Due to this, in the case of performing an image conversion process in consideration of the posture of the image capturing device during the image capturing, the upper and lower directions of the stereoscopic image can be accurately displayed, but the stereoscopic vision may not be obtained from the stereoscopic image.

It is desirable to perform an appropriate image process according to an image capturing mode.

According to an embodiment of the present disclosure, there are provided an image processing apparatus, a control method thereof, and a program causing a computer to execute the corresponding method. The image processing apparatus includes a posture detection unit detecting a posture of the image processing apparatus; an image capturing unit capturing a subject and generating a planar image that includes the subject or a stereoscopic image for stereoscopy of the subject; a mode setting unit setting any one of a planar image capturing mode for recording the planar image and a stereoscopic image capturing mode for recording the stereoscopic image on the basis of user operation; an image conversion unit converting the image that is generated by the image capturing unit through performing of an aspect conversion process and a reduction process with respect to the image; and a control unit operating to record the stereoscopic image on a recording medium regardless of the detected posture of the image processing apparatus if the stereoscopic image capturing mode is set and to record any one of the planar image and a converted image that is an image obtained by converting the planar image through the image conversion unit on the recording medium on the basis of the detected posture of the image processing apparatus if the planar image capturing mode is set. Accordingly, if the stereoscopic image capturing mode is set, the stereoscopic image is recorded regardless of the detected posture of the image processing apparatus, while if the planar image capturing mode is set, any one of the planar image and the converted image is recorded on the basis of the detected posture of the image processing apparatus.

Further, according to an embodiment of the present disclosure, the control unit may operate to record the planar image on the recording medium if a first posture that is a posture in which a length direction and a horizontal direction of a housing of the image processing apparatus coincide with each other is detected, while to record the converted image on the recording medium if a second posture that is a posture in which the length direction and a vertical direction of the housing coincide with each other is detected in the case where the planar image capturing mode is set. Accordingly, if the first posture is detected in the case where the planar image capturing mode is set, the planar image is recorded, while if the second posture is detected, the converted image is recorded.

Further, according to the embodiment of the present disclosure, the image conversion unit may convert the image through rotating of the planar image or the converted image by 180°; and the control unit may operate to record the image obtained through rotating of the planar image through the image conversion unit on the recording medium if a reverse posture that is a posture in which upper and lower directions of the housing of the image processing apparatus are reversed on the basis of the first posture is detected in the case where the planar image capturing mode is set, while to record the image obtained through rotating of the converted image through the image conversion unit on the recording medium if the reverse posture that is a posture in which upper and lower directions of the housing of the image processing apparatus are reversed on the basis of the second posture is detected in the case where the planar image capturing mode is set. Accordingly, if the reverse posture is detected in the case where the planar image capturing mode is set, the image obtained through rotating of the planar image is recorded, while if a vertical posture or the reverse posture is detected, the image obtained through further rotating of the converted image is recorded.

Further, according to the embodiment of the present disclosure, the image capturing unit may include a first image capturing unit generating a first image for displaying the stereoscopic image and a second image capturing unit generating a second image for displaying the stereoscopic image, and the control unit may operate to record the first image and the second image on the recording medium as the stereoscopic image if the stereoscopic image capturing mode is set, while to record any one of the first image and the converted image that is the image obtained by converting the first image through the image conversion unit on the recording medium if the planar image capturing mode is set. Accordingly, if the stereoscopic image capturing mode is set, the first image and the second image are recorded as the stereoscopic image, while if the planar image capturing mode is set, any one of the first image and the converted image is recorded.

Further, according to the embodiment of the present disclosure, the image capturing unit may generate a moving image that is formed by the planar image or a moving image that is formed by the stereoscopic image, and further include an operation reception unit receiving an instruction operation of recording operation start of the moving image, and the control unit may determine whether to record any one of the planar image and the converted image on the recording medium as a moving image that is related to the instruction operation on the basis of the posture of the image processing apparatus that is detected when the instruction operation is received in the case where the planar image capturing mode is set. Accordingly, in the case where the planar image capturing mode is set, it is determined whether to record any one of the planar image and the converted image as the moving image that is related to the instruction operation on the basis of the posture of the image processing apparatus that is detected when the instruction operation of the recording operation start of the moving image is received.

Further, according to the embodiment of the present disclosure, the mode setting unit may set a reproduction mode for displaying any one of the planar image that is recorded on the recording medium, the converted image, and the stereoscopic image on the display unit on the basis of the user operation, the image conversion unit may convert the image that is recorded on the recording medium through performing of the aspect conversion process and an enlargement process with respect to the corresponding image, and the control unit may control the display unit to display the stereoscopic image regardless of the detected posture of the image processing apparatus if the image to be displayed is the stereoscopic image in the case where the reproduction mode is set, and controls the display unit to display any one of the planar image, the converted image, and an image that is newly converted by the image conversion unit on the basis of the detected posture of the image processing apparatus and whether or not the image to be displayed is the converted image if the image to be displayed is not the stereoscopic image. Accordingly, if the image to be displayed is the stereoscopic image in the case where the reproduction mode is set, the stereoscopic image is displayed regardless of the detected posture of the image processing apparatus, while if the image to be displayed is not the stereoscopic image, any one of the planar image, the converted image, and the newly converted image is displayed on the basis of the detected posture of the image processing apparatus and whether or not the image to be displayed is the converted image.

According to another embodiment of the present disclosure, there are provided an image processing apparatus, a control method thereof, and a program causing a computer to execute the corresponding method. The image processing apparatus includes a posture detection unit detecting a posture of the image processing apparatus; an image capturing unit capturing a subject and generating a planar image that includes the subject or a stereoscopic image for stereoscopy of the subject; a mode setting unit setting any one of a planar image capturing mode for recording the planar image and a stereoscopic image capturing mode for recording the stereoscopic image on the basis of user operation; an image conversion unit converting the image that is generated by the image capturing unit through performing of an aspect conversion process and a reduction process with respect to the image; and a control unit operating to transmit stereoscopic image information for displaying the stereoscopic image to a display device regardless of the detected posture of the image processing apparatus if the stereoscopic image capturing mode is set, and to transmit image information for displaying any one image of the planar image and a converted image that is an image obtained by converting the planar image through the image conversion unit to the display device on the basis of the detected posture of the image processing apparatus if the planar image capturing mode is set. Accordingly, if the stereoscopic image capturing mode is set, the stereoscopic image is transmitted regardless of the detected posture of the image processing apparatus, while if the planar image capturing mode is set, image information for displaying any one image of the planar image and the converted image is transmitted on the basis of the detected posture of the image processing apparatus.

According to still another embodiment of the present disclosure, there are provided an image processing apparatus, a control method thereof, and a program causing a computer to execute the corresponding method. The image processing apparatus includes a posture detection unit detecting a posture of the image processing apparatus; an image conversion unit converting an image to be displayed through performing of an aspect conversion process and an enlargement process with respect to the image to be displayed in the case where a reproduction mode for making a display unit display a planar image that includes a subject to be captured, a converted image that is obtained by performing the aspect conversion process and a reduction process with respect to the planar image, and the image to be displayed which is acquired from a recording medium that records a stereoscopic image for stereoscopy of the subject is set; and a control unit controlling the display unit to display the stereoscopic image regardless of the detected posture of the image processing apparatus if the image to be displayed is the stereoscopic image in the case where the reproduction mode is set, and controlling the display unit to display any one of the planar image, the converted image, and an image that is newly converted by the image conversion unit on the basis of the detected posture of the image processing apparatus and whether or not the image to be displayed is the converted image if the image to be displayed is not the stereoscopic image. Accordingly, if the image to be displayed is the stereoscopic image in the case where the reproduction mode is set, the stereoscopic image is displayed regardless of the detected posture of the image processing apparatus, while if the image to be displayed is not the stereoscopic image, any one of the planar image, the converted image, and the newly converted image is displayed on the basis of the detected posture of the image processing apparatus and whether or not the image to be displayed is the converted image.

According to the embodiments of the present disclosure, an excellent effect can be obtained, in which the image process can be appropriately performed according to the image capturing mode.

### BRIEF DESCRIPTION OF THE DRAWINGS

FIGS. 1A and 1B are views illustrating an example of an external configuration of an image capturing device according to a first embodiment of the present disclosure;

FIGS. 2A and 2B are views illustrating an example of an external configuration of an image capturing device according to a first embodiment of the present disclosure;

FIG. 3 is a block diagram illustrating an example of an internal configuration of an image capturing device according to a first embodiment of the present disclosure;

FIG. 4 is a block diagram illustrating an example of a functional configuration of an image capturing device according to a first embodiment of the present disclosure;

FIGS. 5A and 5B are views illustrating the relationship between an image capturing operation that is performed using an image capturing device and a captured image generated by the image capturing operation according to a first embodiment of the present disclosure;

FIGS. 6A to 6C are views illustrating the relationship between an image capturing operation that is performed using an image capturing device and a captured image generated by the image capturing operation according to a first embodiment of the present disclosure;

FIGS. 7A to 7D are views illustrating an example of the relationship between the posture of an image capturing device during an image capturing operation and a captured image generated by the posture according to a first embodiment of the present disclosure;

FIGS. 8A and 8B are views illustrating an example of the relationship between the posture of an image capturing device during an image capturing operation and a captured image generated by the posture according to a first embodiment of the present disclosure;

FIGS. 9A to 9C are views illustrating an example of the relationship between the posture of an image capturing device during an image capturing operation and an image that is converted by an image conversion unit according to a first embodiment of the present disclosure;

FIGS. 10A to 10C are views illustrating an example of the relationship between the posture of an image capturing device during an image capturing operation and an image that is converted by an image conversion unit according to a first embodiment of the present disclosure;

FIGS. 11A and 11B are views illustrating an example of the relationship between the posture of an image capturing device during an image capturing operation and a stereoscopic image generated by an image capturing unit according to a first embodiment of the present disclosure;

FIGS. 12A and 12B are views illustrating an example of the relationship between the posture of an image capturing device during an image capturing operation and a stereoscopic image generated by an image capturing unit according to a first embodiment of the present disclosure;

FIG. 13 is a flowchart illustrating an example of an image conversion control process that is performed by an image capturing device according to a first embodiment of the present disclosure;

FIGS. 14A to 14C are views illustrating an example of image reproduction in the case of reproducing an image that is recorded by an image capturing device according to a first embodiment of the present disclosure;

FIGS. 15A to 15C are views illustrating an example of image reproduction in the case of reproducing an image that is recorded by an image capturing device according to a first embodiment of the present disclosure; and

FIG. 16 is a flowchart illustrating an example of an image conversion control process that is performed by an image capturing device according to a first embodiment of the present disclosure.

### DETAILED DESCRIPTION OF EMBODIMENTS

Hereinafter, with reference to the accompanying drawings, a form for carrying out the present disclosure (hereinafter referred to as an embodiment) will be described. The explanation thereof will be made in the following order.

1. First embodiment (image conversion control: an example of changing an image conversion process according to an image capturing mode in the case where the image conversion process is performed with respect to an image that is generated by an image capturing unit)

2. Modifications

### 1. First Embodiment

### [Example of External Configuration of an Image Capturing Device]

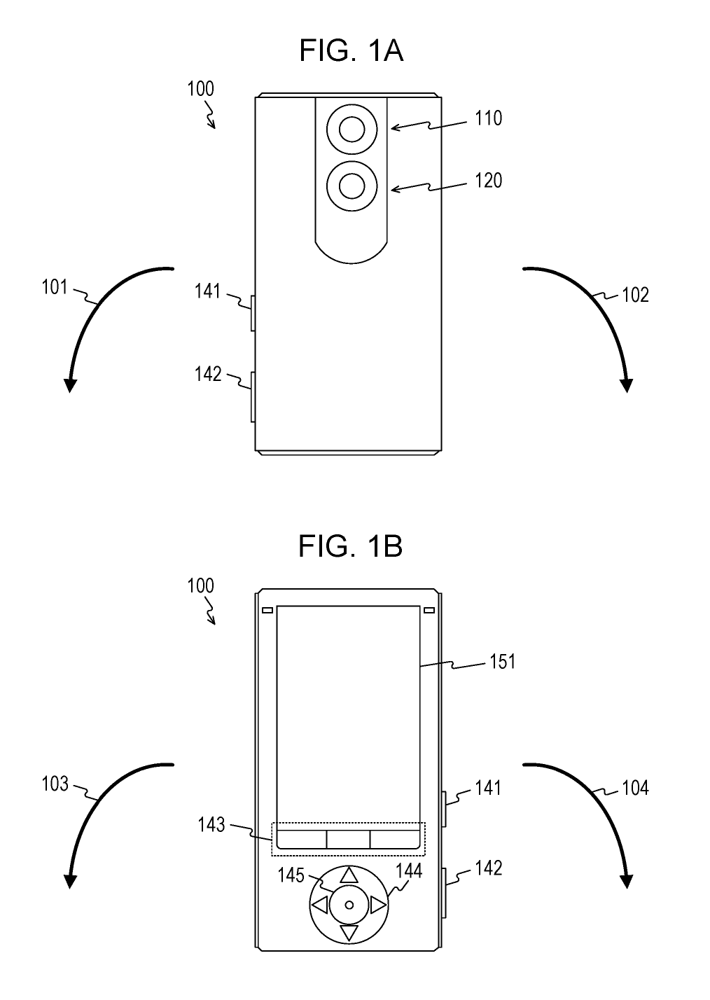

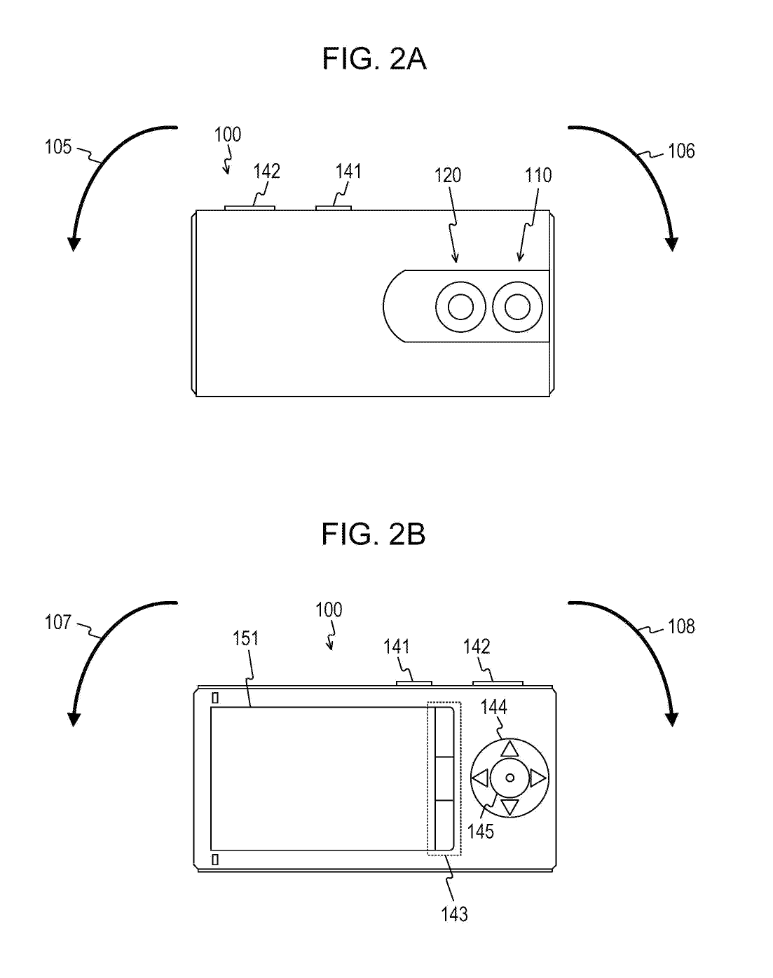

FIGS. 1A to 2B are views illustrating an example of an external configuration of an image capturing device 100 according to an embodiment of the present disclosure.

FIG. 1A is a front view illustrating an external appearance of the front surface of an image capturing device 100 (that is, a surface on which a lens toward a subject is installed). Further, FIG. 1B is a rear view illustrating an external appearance of the rear surface of the image capturing device 100 (that is, a surface of an input/output panel 151 toward a photographer). FIG. 2A is a front view illustrating an external appearance of the front surface of the image capturing device 100 (that is rotated by 90° in a direction indicated by an arrow 102 from a state illustrated in FIG. 1A). Further, FIG. 2B is a rear view illustrating an external appearance of the rear surface of the image capturing device 100 (that is rotated by 90° in a direction indicated by an arrow 103 from a state illustrated in FIG. 1B). The image capturing device 100, for example, is realized by an image capturing device which includes two image capturing units corresponding to stereoscopic photographing, generates two images (image data) through capturing of a subject, and records the respective images (a left-eye image and a right-eye image) in association with each other. This image capturing device, for example, is a digital still camera, a digital video camera (for example, a integrated camera recorder), or the like, which can record the generated images on a recording medium as still image content or moving image content. In this case, the image capturing device 100 is an example of an image processing apparatus according to an embodiment of the present disclosure.

The image capturing device 100 includes a first image capturing unit 110, a second image capturing unit 120, a power switch 141, a shutter button 142, an operation button group 143, up, down, left, and right buttons 144, a record button 145, and an input/output panel 151.

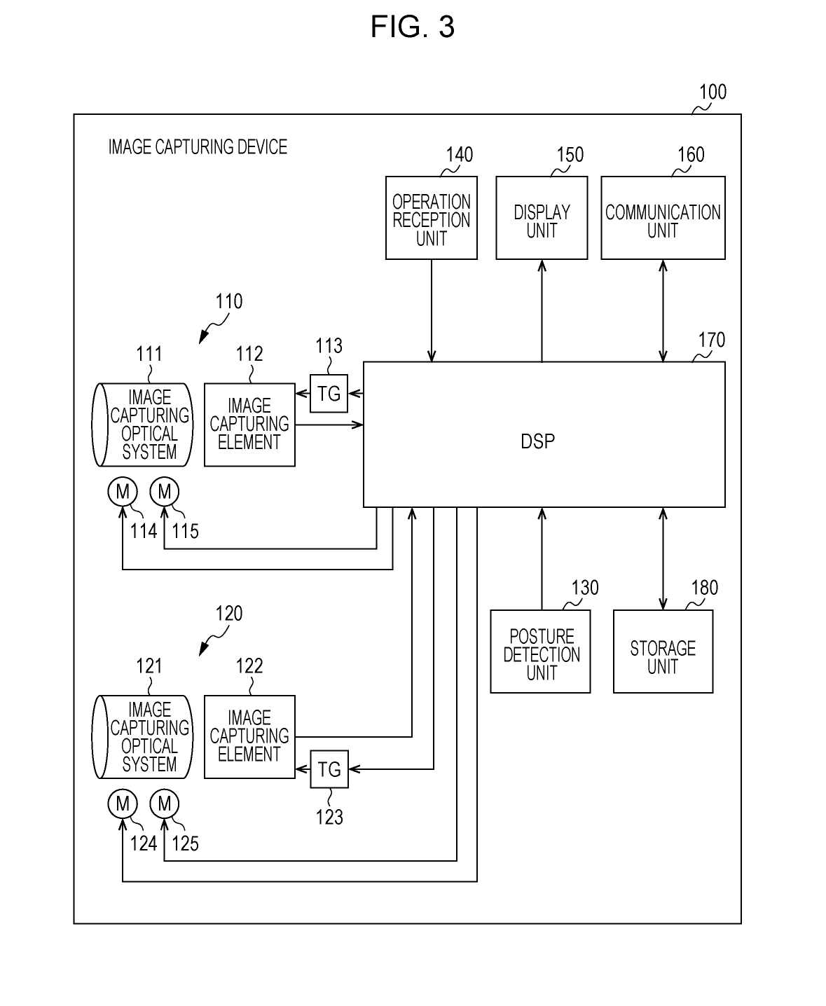

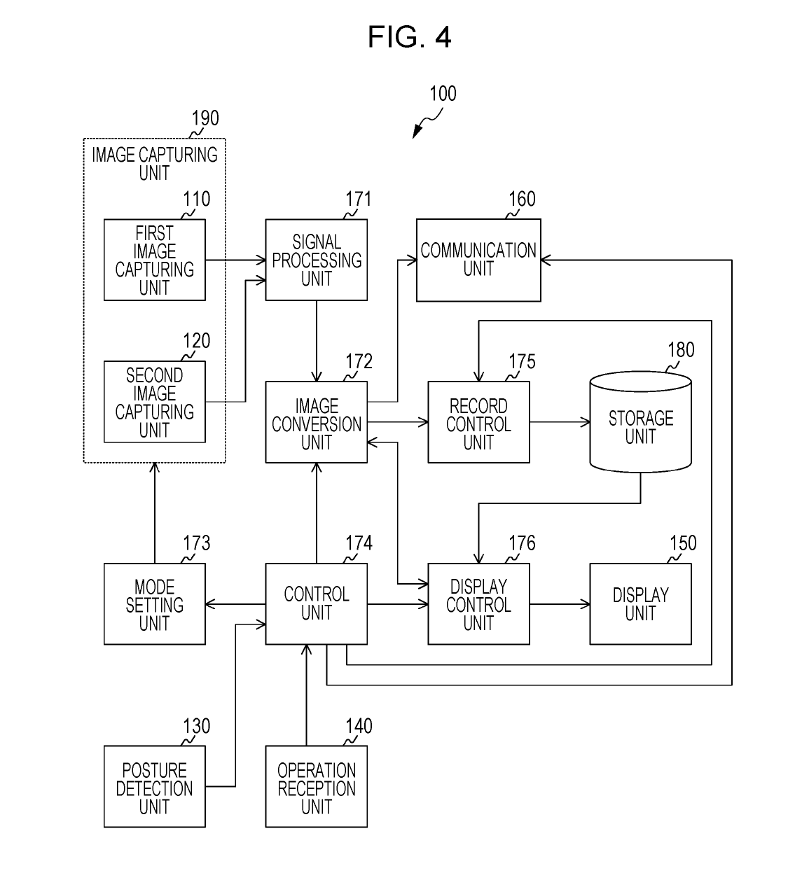

The first image capturing unit 110 and the second image capturing unit 120 capture a subject and generate an image that includes the subject. For example, if a planar image capturing mode (2D image capturing mode) for recording a planar image (2D image) is set, the first image capturing unit 110 captures the subject and generates an image (planar image) that includes the subject. Further, if a stereoscopic image capturing mode (3D image capturing mode) for recording a stereoscopic image (3D image) is set, the first image capturing unit 110 and the second image capturing unit 120 generate a stereoscopic image. That is, the first image capturing unit 110 generates a left-eye image for generating the stereoscopic image, and the second image capturing unit 120 generates a right-eye image for generating the stereoscopic image. Further, for example, in the case of performing a capturing operation of the stereoscopic image, the capturing operation is performed in a state illustrated in FIGS. 2A and 2B. In this case, in the first embodiment of the present disclosure, the state illustrated in FIGS. 2A and 2B is called a horizontal state (or horizontal posture) of the image capturing device 100. That is, the horizontal state of the image capturing device 100 is a state in which the horizontal direction and the length direction of the image capturing device 100 are in the same direction in the case where the surface (the front surface) on which the first image capturing unit 110 and the second image capturing unit 120 are installed is toward the subject. Further, in the first embodiment of the present disclosure, the state illustrated in FIGS. 1A and 1B is called a vertical state (or vertical posture) of the image capturing device 100. That is, the vertical state of the image capturing device 100 is a state in which the vertical direction and the length direction of the image capturing device 100 are in the same direction in the case where the surface (the front surface) on which the first image capturing unit 110 and the second image capturing unit 120 are installed is toward the subject. The first image capturing unit 110 and the second image capturing unit 120 will be described in detail with reference to FIGS. 3 and 4.

The power switch 141 is an operating member that is used when the power of the image capturing device 100 is turned on/off.

The shutter button 142 is an operating member that is pressed by a user when an image (image data) that is generated by at least one of the first image capturing unit 110 and the second image capturing unit 120 is recorded as the content (still image content). For example, if the shutter button 142 is half-pressed in the case where the stereoscopic image capturing mode (3D image capturing mode) is set, a focus control for performing an auto focus is performed. Further, if the shutter button 142 is fully pressed, the corresponding focus control is performed, and the image (image data) that is generated by the first image capturing unit 110 and the second image capturing unit 120 is recorded as the content (still image (stereoscopic image) content). Through this recording process, the content (still image (stereoscopic image) content), for example, is recorded in a storage unit 180 illustrated in FIG. 3.

The operation button group 143 includes operation buttons used when various kinds of operations are performed.

The up, down, left, and right buttons 144 are operation buttons that are used when various kinds of operations regarding up, down, left, and right directions.

The record button 145 is an operation member that is pressed by a user when an image (image data) that is generated by at least one of the first image capturing unit 110 and the second image capturing unit 120 is recorded as the content (moving image content). For example, if the record button 145 is pressed in the case where the stereoscopic image capturing mode is set, recording of the image (image data) that is generated by the first image capturing unit 110 and the second image capturing unit 120 starts. Further, if the record button 145 is pressed again, the recording of the image (image data) is terminated. Through this recording process, the content (moving image (stereoscopic image) content), for example, is recorded in the recording in the storage unit 180 illustrated in FIG. 3.

The input/output panel 151 displays various kinds of images, and receives an operation input from the user on the basis of the detection state of an object that approaches to or is in contact with a display surface. In this case, the input/output panel 151 is also called a touch screen or a touch panel. The input/output panel 151 is provided with an operation reception unit and a display panel. For example, as the operation reception unit, an electrostatic (capacitance) type touch panel that detects the contact or approach of the object having conductivity (for example, a finger of a person) on the basis of the change of the capacitance may be used. Further, for example, as the display panel, a display panel such as an LCD (Liquid Crystal Display), an organic EL (Electro Luminescence) panel, or the like may be used. Further, the input/output panel 151, for example, is configured by making a transparent touch panel overlap the display surface of the display panel.

### [Example of an Internal Configuration of an Image Capturing Device]

FIG. 3 is a block diagram illustrating an example of an internal configuration of an image capturing device 100 according to a first embodiment of the present disclosure.

The image capturing device 100 includes a first image capturing unit 110, a second image capturing unit 120, a posture detection unit 130, an operation reception unit 140, a display unit 150, a communication unit 160, a DSP (Digital Signal Processor) 170, and a storage unit 180.

The first image capturing unit 110 and the second image capturing unit 120 are configured so that optical systems and respective image capturing elements constitute left and right sets to generate a left-eye image and a right-eye image. That is, the first image capturing unit 110 includes an image capturing optical system 111, an image capturing element 112, a TG (Timing Generator) 113, and optical component driving units 114 and 115. Further, the second image capturing unit 120 includes an image capturing optical system 121, an image capturing element 122, a TG 123, and optical component driving units 124 and 125.

In this case, the respective configurations (the respective optical system, the respective image capturing elements, and the like) of the first image capturing unit 110 and the second image capturing unit 120 are substantially the same except for the point that their arrangement positions are different from each other. Accordingly, hereinafter, any one of left and right configurations will be described while description of a part thereof will be omitted.

The image capturing optical system 111 is an optical system that is optically designed to capture a subject in one direction, and includes optical components such as various kinds of lenses including a focus lens and a zoom lens, an optical filter removing an unnecessary wavelength, an iris, and the like. An optical image (image of the subject) incident from the subject is formed on an exposure surface of the image capturing element 112 through the respective optical components of the image capturing optical system 111. Further, in the image capturing optical system 111, the optical component driving units 114 and 115 are mechanically connected to drive the optical components that constitute the image capturing optical system 111.

The image capturing element 112 performs photoelectric conversion of the optical image that is supplied from the image capturing optical system 111 and generates and outputs an electric signal (analog image signal) to the DSP 170. As the image capturing element 112, for example, a solid-state image capturing element (image sensor) such as a CCD (Charge Coupled Device) or a CMOS (Complementary Metal Oxide Semiconductor) may be used.

The TG 113 is a timing generator that generates an operation pulse that is necessary for the image capturing element 112 under the control of the DSP 170. The TG 113, for example, generates various kinds of pulses, such as a four-phase pulse for vertical transmission, a field shift pulse, a two-phase pulse for horizontal transmission, and a shutter pulse, and supplies the generated pulses to the image capturing element 112. Further, as the TG 113 drives the image capturing element 112, the image of the subject is captured. Further, the TG 113 adjusts the shutter speed of the image capturing element 112 to control the exposure amount and the exposing period of the captured image (electronic shutter function).

The optical component driving units 114 and 115 drive the optical components that constitute the image capturing optical system 111 under the control of the DSP 170, and for example, includes a zoom motor, a focus motor, and the like. The optical component driving units 114 and 115, for example, adjust the iris by moving the zoom lens and the focus lens that constitute the image capturing optical system 111.

The posture detection unit 130 detects the posture of the image capturing device 100 by detecting acceleration, movement, slope, and the like of the image capturing device 100, and outputs information on the detected posture (posture information) to the DSP 170. The posture detection unit 130, for example, is realized using a gyro sensor. Through this gyro sensor, the angular velocity of the image capturing device 100 (rotational angular velocity in three-axis directions) is detected and thus the posture of the image capturing device 100 is detected. In this case, the acceleration, the movement, and the slope of the image capturing device 100 may be detected using other sensors (for example, an acceleration sensor, a magnetic sensor, and the like) except for the gyro sensor, and on the basis of the result of the detection, the posture of the image capturing device 100 and its change may be detected.

The operation reception unit 140 is an operation reception unit that receives the operation input from the user, and outputs the operation signal according to the received operation input to the DSP 170. The operation reception unit 140, for example, corresponds to the power switch 141, the shutter button 142, the operation button group 143, the up, down, left, and right buttons 144, the record button 145, and the input/output panel 151 illustrated in FIGS. 1A to 2B.

The display unit 150, for example, includes an LCD (Liquid Crystal Display), an organic EL display, and the like. The display unit 150 displays various kinds of input image data under the control of the DSP 170. For example, the display unit 150 displays the captured image being photographed (through-image) that is input in real time from the DSP 170 during the image capturing operation. During the image capturing operation, the captured image (through-image) is displayed regardless of the posture of the image capturing device 100. Accordingly, the user can operate the image capturing device 100 while the user sees the image during the image capturing operation through the display unit 150. Further, in the case where a reproduction instruction operation has been performed with respect to the content stored in the storage unit 180, the display unit 150 displays the content input from the DSP 170. Accordingly, the user can confirm the content that is stored in the storage unit 180. The display unit 150, for example, corresponds to the input/output panel 151 illustrated in FIGS. 1A to 2B.

The communication unit 160 is a communication unit for outputting the captured image that is generated by the first image capturing unit 110 and the second image capturing unit 120 and the image that is stored in the storage unit 180 to an external device (for example, display device). The communication unit 160, for example, includes an HDMI (High-Definition Multimedia Interface).

The DSP 170 is an operation processing device for performing an image process of the captured image and an operation control of the image capturing device 100. The DSP 170 includes a signal processing unit 171, an image conversion unit 172, a mode setting unit 173, a control unit 174, a record control unit 175, and a display control unit 176 illustrated in FIG. 4. For example, the control unit 174 includes an operation processing device such as a microcontroller that is installed in the DSP 170, and controls the overall operation of the image capturing device 100. The control unit 174, for example, operates on the basis of a program that is stored in a flash ROM (Read Only Memory) or the like that is included in the storage unit 180, and executes various kinds of operation processes that are necessary for the control. The operation processes may be performed using a DRAM (Dynamic Random Access Memory) that is included in the storage unit 180. In this case, the program, which is stored in a disk type recording medium or a removable storage medium such as a memory card or the like, and is supplied to the image capturing device 100, may be used. Further, the program, which is downloaded to the image capturing device 100 through a network such as a LAN (Local Area Network) and the Internet, may be used.

Further, for example, the control unit 174 controls the image capturing operation of the first image capturing unit 110 through control of the TGs 113 and 123 or the optical component driving units 114, 115, 124, and 125. Further, the control unit 174 performs an automatic exposure control (AE function) through adjustment of the iris of the image capturing optical systems 111 and 121, setting of the electronic shutter speed of the image capturing elements 112 and 122, and gain setting of AGC of the signal processing unit 171. Further, the control unit 174 performs an auto focus control (AF function) for automatically adjusting the focus of the image capturing optical systems 111 and 121 with respect to a specified subject by moving the focus lens of the image capturing optical systems 111 and 121. Further, the control unit 174 adjusts the viewing angle of the captured image by moving the zoom lens of the image capturing optical systems 111 and 121. Further, the control unit 174 controls the recording process of the image data through the record control unit 175 and the reproduction process of the image data through the display control unit 176. Further, the control unit 174 performs a display control for displaying various kinds of display data on the display unit 150. In this case, respective units that constitute the DSP 170 will be described in detail with reference to FIG. 4.

The storage unit 180 is a storage unit for storing various kinds of data (for example, data used for the respective processes in the image capturing device 100). As the storage unit 180, for example, a semiconductor memory, an optical disc, or a hard disk may be used. In this case, as the semiconductor memory, a flash ROM (Read Only Memory), a DRAM (Dynamic Random Access Memory), or the like, may be used. Further, as the optical disc, a BD (Blu-ray Disc), a DVD (Digital Versatile Disc), a CD (Compact Disc), or the like, may be used. As the storage unit 180, a storage device that is built in the image capturing device 100 may be used, or a removable medium (recording medium) such as a memory card that is detachably attached to the image capturing device 100. Further, as the storage unit 180, plural kinds of storage devices or removable media may be used.

### [Example of a Functional Configuration of an Image Capturing Device]

FIG. 4 is a block diagram illustrating an example of a functional configuration of an image capturing device 100 according to a first embodiment of the present disclosure. In this case, the same reference numerals are given to the same functional configurations as those illustrated in FIG. 3, and parts of their descriptions will be omitted. Further, illustration and description of parts of the signal lines will be omitted.

The image capturing device 100 includes an image capturing unit 190, a posture detection unit 130, an operation reception unit 140, a display unit 150, and a communication unit 160. Further, the image capturing device 100 includes a signal processing unit 171, an image conversion unit 172, a mode setting unit 173, a control unit 174, a record control unit 175, a display control unit 176, and a storage unit 180. In this case, the image capturing unit 190 includes a first image capturing unit 110 and a second image capturing unit 120.

The image capturing unit 190 is an image capturing unit that captures a subject and generates a planar image that includes the subject or a stereoscopic image for stereoscopy of the subject, and performs an image capturing process according to the image capturing mode set by the mode setting unit 173. That is, any one mode of a planar image capturing mode, a stereoscopic image capturing mode, and a reproduction mode is set by the mode setting unit 173. The planar image capturing mode is an image capturing mode for recording the planar image. Further, the stereoscopic image capturing mode is an image capturing mode for recording the stereoscopic image. In this case, it is assumed that the above-described image capturing modes can be set to any one of a still image capturing mode for recording a still image and a moving image capturing mode for recording a moving image. That is, in the case where any one image capturing mode of the planar image capturing mode and the stereoscopic image capturing mode is set, any one of a still image recording operation and a moving image recording operation can be performed on the basis of the user operation. Further, the reproduction mode is a mode for performing reproduction of image content that is stored in the storage unit 180.

Specifically, the image capturing unit 190 includes the first image capturing unit 110 and the second image capturing unit 120. For example, in the case where the planar image capturing mode is set, the first image capturing unit 110 generates the planar image by capturing the subject in a specified direction (for example, optical axis direction). Further, in the case where the stereoscopic image capturing mode is set, the first image capturing unit 110 and the second image capturing unit 120 generate the stereoscopic image. That is, the first image capturing unit 110 generates a first image (left-eye image) for displaying the stereoscopic image by capturing the subject in the specified direction, and the second image capturing unit 120 generates a second image (right-eye image) for displaying the stereoscopic image. Further, the image capturing unit 190 outputs the image (image data) as generated above to the signal processing unit 171.

The posture detection unit 130 detects the posture of the image capturing device 100, and outputs the posture information on the detected posture to the control unit 174.

The operation reception unit 140 is an operation reception unit that receives the operation input from the user, and outputs the operation signal according to the received operation input to the control unit 174. For example, the operation reception unit 140 receives an instruction operation of the recording operation of the still image and an instruction operation of a recording operation start (or recording operation end) of the moving image. Further, the operation reception unit 140 receives a setting operation for setting the mode.

The signal processing unit 171, under the control of the control unit 174, executes a predetermined signal process with respect to the image (image data) output from the image capturing unit 190, and supplies the image (image data) after the signal process to the image conversion unit 172. For example, the signal processing unit 171 performs a predetermined signal process with respect to the image signal (analog image signal) output from the image capturing elements 112 and 122 illustrated in FIG. 3, and supplies the image signal (digital image signal) after the signal process to the respective units. Further, the signal processing unit 171, for example, includes an analog signal processing unit, an A/D (Analog/Digital) conversion unit, and a digital signal processing unit. The analog signal processing unit is a processing unit preprocessing the image signal (so-called analog frontend). This analog signal processing unit, for example, performs a CDS (Correlated Double Sampling) process and a gain process by a programmable gain amplifier (PGA) with respect to the image signal output from the image capturing elements 112 and 122. The A/D conversion unit converts the image signal (analog image signal) output from the analog signal processing unit into a digital image signal and outputs the digital image signal to the digital signal processing unit. The digital signal processing unit, for example, performs digital signal processes, such as noise removal, white valance adjustment, color correction, edge enhancement, and gamma correction, with respect to the digital image signal output from the A/D conversion unit, and outputs the processed digital image signal to the respective units. In this case, the signal processing unit 171 may not execute the analog and digital signal processes. For example, the first image capturing unit 110 and the second image capturing unit 120 may output the digital image signal, and the signal processing unit 171 may execute only the digital signal process.

The image conversion unit 172, under the control of the control unit 174, performs various kinds of image conversion processes with respect to the image (image data) output from the signal processing unit 171, and outputs the image, of which the image conversion process has been performed, to the communication unit 160, the record control unit 175, or the display control unit 176. Further, during the setting of the reproduction mode, the image conversion unit 172 performs various kinds of image conversion processes with respect to the image (image data) output from the display control unit 176 under the control of the control unit 174, and outputs the image, of which the image conversion process has been performed, to the communication unit 160 or the display control unit 176. Further, the image conversion unit 172 performs an image process according to the mode set by the mode setting unit 173. For example, the image conversion unit 172 converts the image by performing the aspect conversion process, the reduction process, and the rotating process (rotation by 180°) with respect to the image generated by the image capturing unit 190 (image output from the signal processing unit 171). Further, the image conversion unit 172 converts the image by performing the aspect conversion process and the enlargement process with respect to the image recorded in the storage unit 180 (image acquired by the display control unit 176). In this case, if the image conversion is unnecessary, the image conversion unit 172 does not perform the image conversion process with respect to the image (image data) output from the signal processing unit 171, and outputs the image to the communication unit 160, the record control unit 175, or the display control unit 176. Further, in the case of displaying the through-image to the display unit 150 during the setting of the image capturing mode, the image conversion unit 172 outputs the image output from the signal processing unit 171 (image of which the image conversion process has not been performed) to the display control unit 176.

The mode setting unit 173 sets the image capturing mode or the reproduction mode under the control of the control unit 174. Specifically, the mode setting unit 173 sets any one of the planar image capturing mode, the stereoscopic image capturing mode, and the reproduction mode. For example, the respective modes are set on the basis of the user operation that is received by the operation reception unit 140.

The control unit 174 performs the overall control of the image capturing device 100. For example, the control unit 174 performs the control according to the user's operation input that is received by the operation reception unit 140.

Further, for example, during the setting of the stereoscopic image capturing mode, the control unit 174 performs the control to record the stereoscopic image in the storage unit 180 regardless of the posture of the image capturing device 100 that is detected by the posture detection unit 130. Further, during the setting of the planar image capturing mode, the control unit 174 performs the control to record any one of the planar image and the image obtained by converting the planar image through the image conversion unit 172 (converted image) in the storage unit 180 on the basis of the posture of the image capturing device 100 that is detected by the posture detection unit 130. In this case, the control unit 174 performs the control to record the planar image in the storage unit 180 if a posture in which the length direction and the horizontal direction of a housing of the image capturing device 100 coincide with each other (first posture (basic posture)) is detected, while the control unit 174 performs the control to record the converted image in the storage unit 180 if a posture in which the length direction and a vertical direction of the housing of the image capturing device 100 coincide with each other (second posture (vertical posture) is detected in the case where the planar image capturing mode is set.

However, it is assumed that a posture in which the upper and lower directions of the housing of the image capturing device 100 are reversed (reverse posture) on the basis of the first posture (basic posture) is detected in the case where the planar image capturing mode is set. In this case, the control unit 174 performs the control to record the image that is obtained by rotating the planar image (by 180°) through the image conversion unit 172 in the storage unit 180. Further, it is assumed that a posture in which the upper and lower directions of the housing of the image capturing device 100 are reversed (vertical posture or reverse posture) on the basis of the second posture (vertical posture) is detected. In this case, the control unit 174 performs the control to record the image that is obtained by further rotating the converted image (by 180°) through the image conversion unit 172 in the storage unit 180.

Further, in the case where the planar image capturing mode is set, the control unit 174 performs the above-described image conversion process on the basis of the posture of the image capturing device 100 that is detected by the posture detection unit 130 when the operation reception unit 140 receives an instruction operation of a recording operation start of a moving image. That is, the control unit 174 determines to record any one of the planar image and the converted image in the storage unit 180 as a moving image according to the instruction operation on the basis of the posture of the image capturing device 100 that is detected by the posture detection unit 130 when the instruction operation is received.

Further, in the case where the stereoscopic image capturing mode is set, the control unit 174 performs the control to transmit stereoscopic image information for displaying the stereoscopic image to an external display device regardless of the posture of the image capturing device 100 that is detected by the posture detection unit 130. Further, in the case where the planar image capturing mode is set, the control unit 174 performs the control to transmit image information for displaying any one of the planar image and the converted image to the display device on the basis of the posture of the image capturing device 100 that is detected by the posture detection unit 130.

Further, if the image to be displayed is the stereoscopic image in the case where the reproduction mode is set, the control unit 174 controls the display unit 150 to display the stereoscopic image regardless of the posture of the image capturing device 100 that is detected by the posture detection unit 130. Further, if the image to be displayed is not the stereoscopic image, the control unit 174 controls the display unit 150 to display any one of the planar image, the converted image, and an image that is newly converted by the image conversion unit 172 on the basis of the detected posture and whether or not the image to be displayed is the converted image.

The record control unit 175 performs a compression recording process of an image that is output from the image conversion unit 172 under the control of the control unit 174. For example, the record control unit 175 compresses the captured image (frame) with a predetermined recording format if a record button 145 (illustrated in FIGS. 1A and 1B) is pressed in the case where the image capturing mode is set. Further, the record control unit 175 performs recording of the compressed image data in the storage unit 180 as moving image content. In this case, as the predetermined recording format, for example, MPEG (Moving Picture Experts Group) 4 may be used. Further, the record control unit 175 compresses the captured image (still image) in a predetermined compression coding method and records the compressed image in the storage unit 180 as the still image content if the shutter button 142 (illustrated in FIGS. 2A and 2B) is pressed in the case where the image capturing mode is set. Further, when the record control unit 175 records the image output from the image conversion unit 172 in the storage unit 180, it adds meta data (accompanying information) to the image.

The display control unit 176 displays the image output from the image conversion unit 172 or the image stored in the storage unit 180 on the display unit 150 under the control of the control unit 174. For example, in the case where the image capturing mode is set, the display control unit 176 displays the image output from the image conversion unit 172 (image of which the image conversion process has not been performed) on the display unit 150 as the through-image. Further, in the case where the reproduction mode is set, the display control unit 176 acquires the image content according to the reproduction instruction operation from the operation reception unit 140 from the storage unit 180, extends the compressed image data, and displays the extended image data on the display unit 150. Further, the display control unit 176 acquires the meta data that is added to the image content acquired from the storage unit 180, and outputs the meta data to the control unit 174. If the image conversion of the image that corresponds to the image content through the image conversion unit 172 is necessary, on the basis of the meta data, the display control unit 176 outputs the image content to the image conversion unit 172. Further, the image conversion unit 172 performs the image conversion process of the image that corresponds to the image content, and outputs the converted image to the display control unit 176.

### [Example of an Image Capturing Operation and Example of an Image Generated Accordingly]

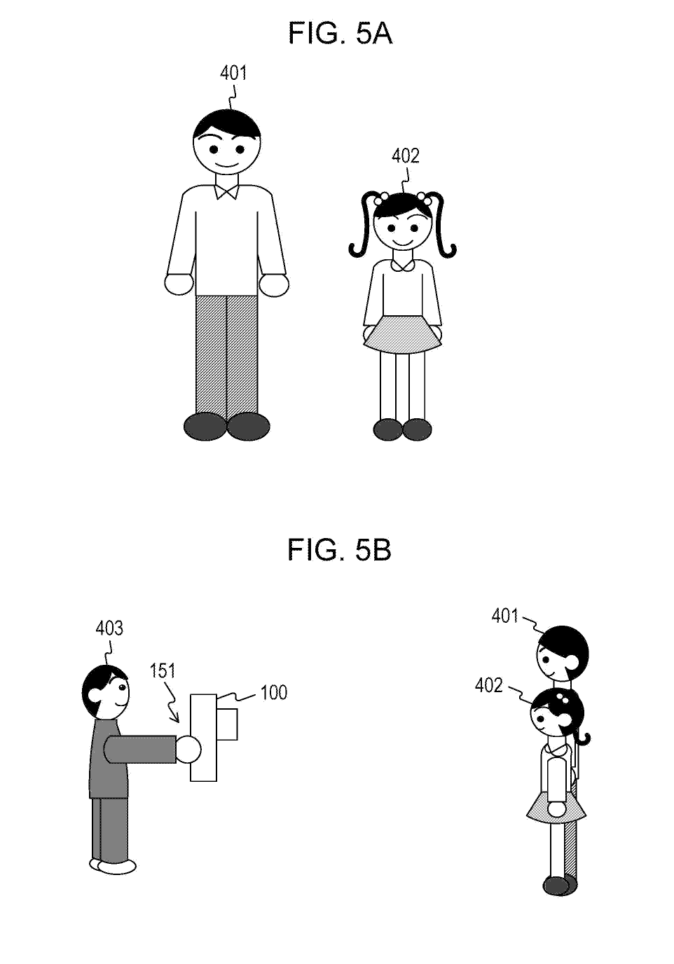

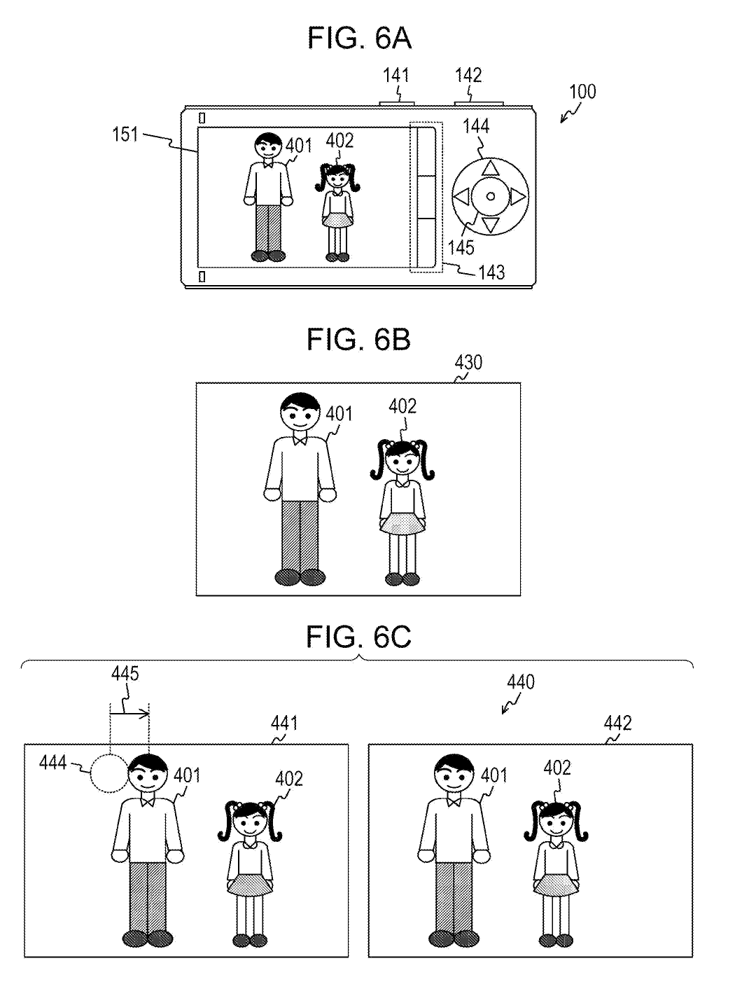

FIGS. 5A to 6C are views illustrating the relationship between an image capturing operation that is performed using an image capturing device 100 and a captured image generated by the image capturing operation according to a first embodiment of the present disclosure.

FIG. 5A illustrates persons 401 and 402 who are the subjects of the image capturing operation (to be captured) using the image capturing device 100. FIG. 5B illustrates image capturing operation (image capturing operation by a person 403) when viewed from the side in the case of recording an image of the persons 401 and 402 illustrated in FIG. 5A as the subjects. In FIGS. 5A and 5B, for easiness in explanation, the persons 401 and 402 and the background are illustrated in a simplified manner.

FIG. 6A illustrates an example of a through-image that is displayed on the input/output panel 151 in the case where the image capturing operation is performed in a state illustrated in FIG. 5B using the image capturing device 100 in a horizontal state.

FIG. 6B illustrates the image that is recorded when the shutter button 142 is fully pressed (planar image 430) in a state illustrated in FIG. 6A in the case where the planar image capturing mode is set. In the case where the planar image capturing mode is set as described above, the image (planar image 430) generated by the first image capturing unit 110 becomes the image to be recorded. This planar image 430 is a horizontal image in which the persons 401 and 402 are arranged side by side.

FIG. 6C illustrates the image that is recorded when the shutter button 142 is fully pressed (stereoscopic image 440) in a state illustrated in FIG. 6A in the case where the stereoscopic image capturing mode is set. In the case where the stereoscopic image capturing mode is set as described above, the image (stereoscopic image 440) generated by the first image capturing unit 110 and the second image capturing unit 120 becomes the image to be recorded. This stereoscopic image 440 includes a left-eye image 441 generated by the first image capturing unit 110 and a right-eye image 442 generated by the second image capturing unit 120. The left-eye image 441 and the right-eye image 442 are one set of images for displaying the stereoscopic image, and subjects (persons 401 and 402) included in the image capturing range are shifted in the horizontal direction (indicated by an arrow 445). In this case, a dotted ellipse 444 indicates an outline of the face of the person 401 that is included in the right-eye image 442.

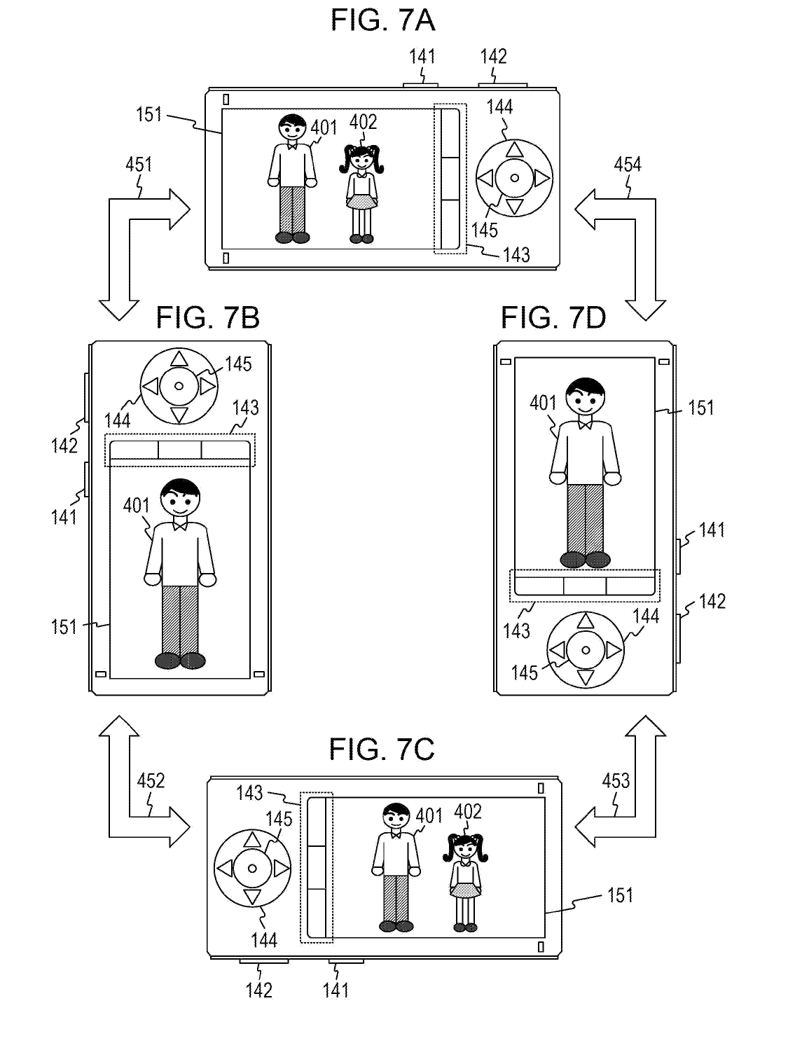

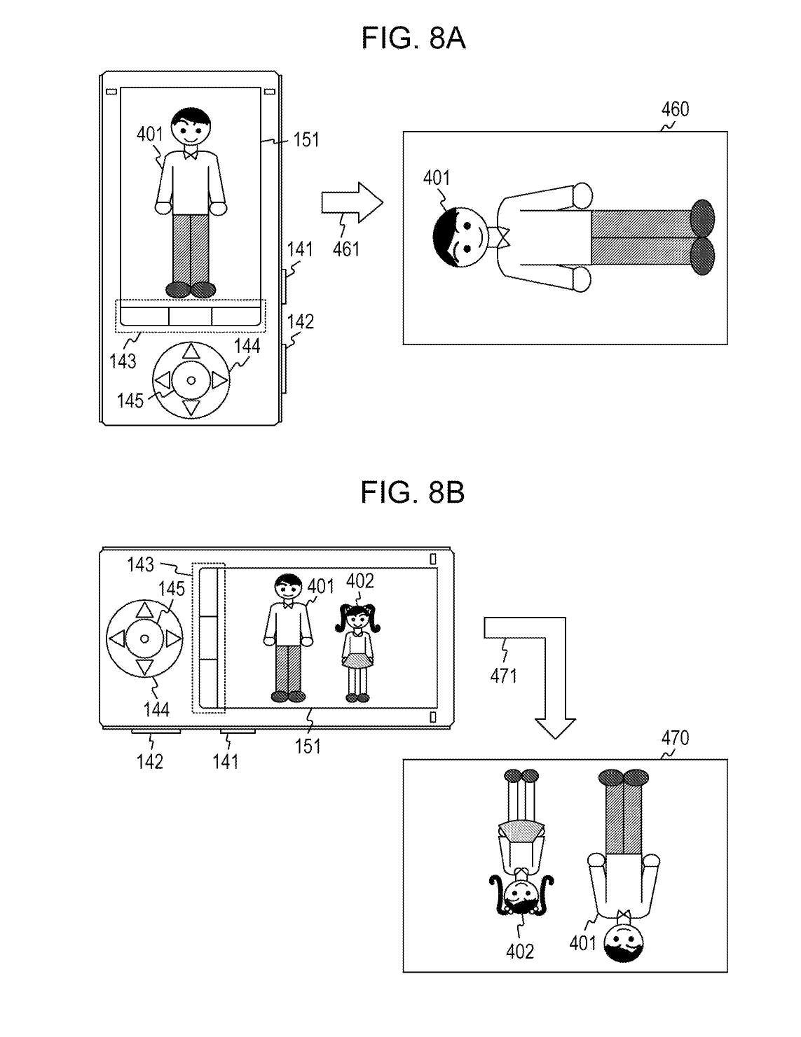

In the case of performing the image capturing operation using the image capturing device 100 as described above, plural kinds of captured images can be recorded. Further, by changing the posture of the image capturing device 100, the captured image having different composition can be recorded. This example is illustrated in FIGS. 7A to 8B.

### [Example of the Relationship Between the Posture of the Image Capturing Device and the Captured Image]

FIGS. 7A to 8B are views illustrating an example of the relationship between the posture of the image capturing device 100 during the image capturing operation and the captured image generated by the posture according to a first embodiment of the present disclosure.

FIGS. 7A to 7D illustrates four kinds of postures as the postures of the image capturing device 100 that performs the image capturing operation with respect to the persons 401 and 402 as the subjects. In this case, by rotating the image capturing device 100 by 90° (arrows 451 to 454) about the optical axis direction, the respective postures illustrated in FIGS. 7A to 7D can be obtained.

Here, in the case of performing the image capturing operation with respect to persons 401 and 402 as the subjects, for example, the image capturing operation is performed in the horizontal state illustrated in FIG. 7A. Hereinafter, the horizontal state illustrated in FIG. 7A is called a basic posture. Further, in the case of performing the image capturing operation with respect to only the person 401 as the subject, for example, the image capturing operation is performed in the horizontal state (vertical posture) illustrated in FIG. 7B. However, for example, it is also assumed that a person 403 operates the image capturing device 100 only with his/her left hand. In this case, it is assumed that the posture of the image capturing device 100 becomes the posture illustrated in FIGS. 7C and 7D.

Accordingly, hereinafter, postures of the image capturing device 100 will be described using two classifications. For example, the postures of the image capturing device 100 illustrated in FIGS. 7B and 7D among the postures of the image capturing device 100 illustrated in FIGS. 7A to 7D are called vertical postures. Further, the postures of the image capturing device 100 illustrated in FIGS. 7C and 7D are called reverse postures. Here, although the postures in the case where the image capturing operation is performed using the image capturing device 100 will be described as the posture of the image capturing device 100, it is assumed that similar names (basic posture, vertical posture, and reverse posture) are used even in the case where the image capturing device 100 displays the images.

First, as illustrated in FIGS. 7B and 7D, the case where the image capturing device 100 has the vertical posture will be described. The captured image that is generated in this case becomes the image of which the aspect has been reversed in comparison to the captured image that is generated in the case where the image capturing device 100 has the reverse posture.

Next, as illustrated in FIGS. 7C and 7D, the case where the image capturing device 100 has the reverse posture will be described. For example, in the case where the person 403 performs the image capturing operation (still image capturing operation) with the image capturing device 100 in the hand, the person 403 puts the right hand (for example, the forefinger or thumb) on the shutter button 142 in a state where the input/output panel 151 is visible. Then, the person 403 performs the image capturing operation by pressing the shutter button 142 in the desired timing. Accordingly, in general, in the case where a person performs the image capturing operation (still image capturing operation) with the image capturing device 100 in the hand, the image capturing operation is often performed with the posture illustrated in FIG. 7A or 7B. By contrast, the posture illustrated in FIG. 7C becomes the vertically reversed posture in comparison to the posture that is generally performed as illustrated in FIG. 7A. Accordingly, as described above, the posture of the image capturing device 100 illustrated in FIG. 7C is called the reverse posture.

Further, as described above, as the vertical postures of the image capturing device 100, there are two kinds of postures of the image capturing device 100 illustrated in FIGS. 7B and 7D. Accordingly, in the first embodiment of the present disclosure, in order to discriminate between the two kinds of postures, even the vertical postures are used with distinguished names according to whether or not the posture is the reverse posture.

As described above, in general, in the case where the person performs the image capturing operation (still image capturing operation) with the image capturing device 100 in the hand, the image capturing operation is often performed with the posture illustrated in FIG. 7A or 7B. By contrast, the posture illustrated in FIG. 7D becomes the vertically reversed posture in comparison to the posture that is generally performed as illustrated in FIG. 7B. Accordingly, the posture of the image capturing device 100 illustrated in FIG. 7D is called the vertical posture or the reverse posture.

FIG. 8A illustrates an example of the captured image (planar image 460) that is generated by the first image capturing unit 110 in the case where the image capturing device 100 has the vertical posture. The posture of the image capturing device 100 illustrated in FIG. 8A is the posture obtained by rotating the image capturing device 100 by −90° in the counterclockwise direction about the optical axis direction as the axis from the posture (basic posture) of the image capturing device 100 illustrated in FIG. 7A. In this case, since the first image capturing unit 110 is also rotated by −90° in the counterclockwise (CCW) direction according to the rotation of the image capturing device 100, the person 401 is rotated by 90° and becomes in the lying state on his/her side even in the planar image 460 that is generated by the first image capturing unit 110.

FIG. 8B illustrates an example of the captured image (planar image 470) that is generated by the first image capturing unit 110 in the case where the image capturing device 100 has the vertical posture or the reverse posture. The posture of the image capturing device 100 illustrated in FIG. 8B is the posture obtained by rotating the image capturing device 100 by 180° in the counterclockwise (CCW) direction about the optical axis direction as the axis from the posture (basic posture) of the image capturing device 100 illustrated in FIG. 7A. In this case, since the first image capturing unit 110 is also rotated by 180° according to the rotation of the image capturing device 100, the persons 401 and 402 are rotated by 180° even in the planar image 470 that is generated by the first image capturing unit 110.

In the case of displaying the planar images 460 and 470 that are generated by the posture of the image capturing device 100 illustrated in FIGS. 8A and 8B on the input/output panel 151, an influence is exerted by the posture of the image capturing device 100. For example, it is assumed that the planar image that is obtained and recorded by the image capturing operation performed in the posture of the image capturing device 100 illustrated in FIG. 7A is reproduced in the posture of the image capturing device 100 illustrated in FIG. 7B. In this case, in the planar image (reproduced image) that is displayed on the input/output panel 151, the persons 401 and 402 are displayed so that they are rotated by −90° in the CCW direction and become in the lying state on the side.

Further, for example, it is assumed that the planar image that is obtained and recorded by the image capturing operation performed in the posture of the image capturing device 100 illustrated in FIG. 7A is reproduced in the posture of the image capturing device 100 illustrated in FIG. 7C. In this case, in the planar image (reproduced image) that is displayed on the input/output panel 151, the persons 401 and 402 are displayed so that they are rotated by 180° in the CCW direction (that is, they are vertically reversed).

As described above, depending on the posture of the image capturing device 100 during the image capturing operation and the posture of the image capturing device 100 during the image reproduction, the image may not be properly displayed during the image reproduction. According to the first embodiment of the present disclosure, the captured image is converted and recorded on the basis of the posture of the image capturing device 100 during the image capturing operation.

### [Example of Image Conversion]

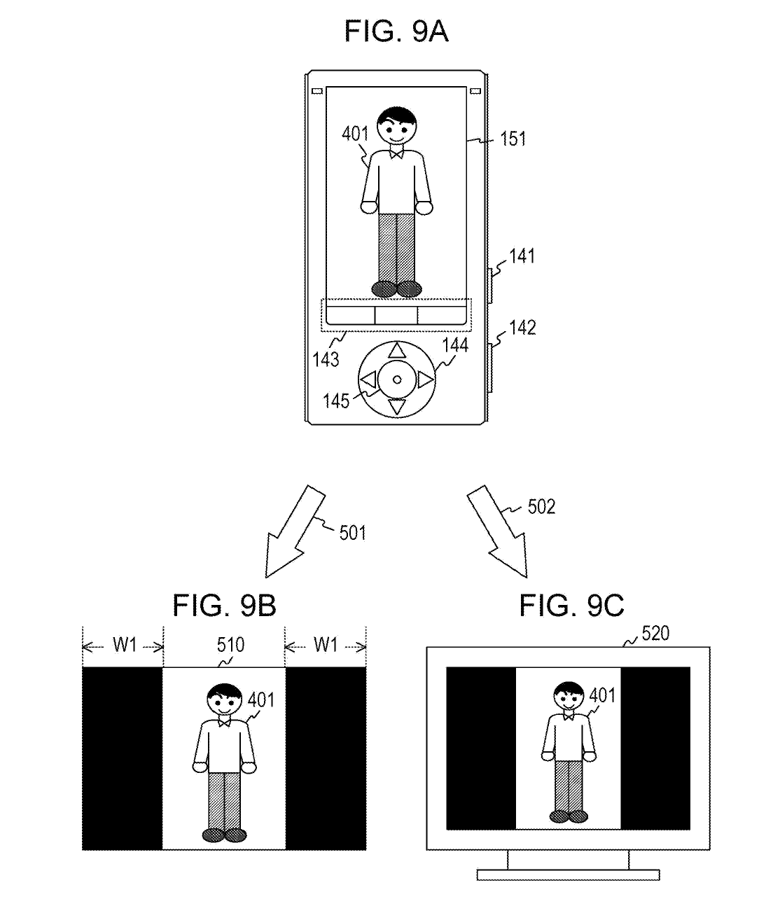

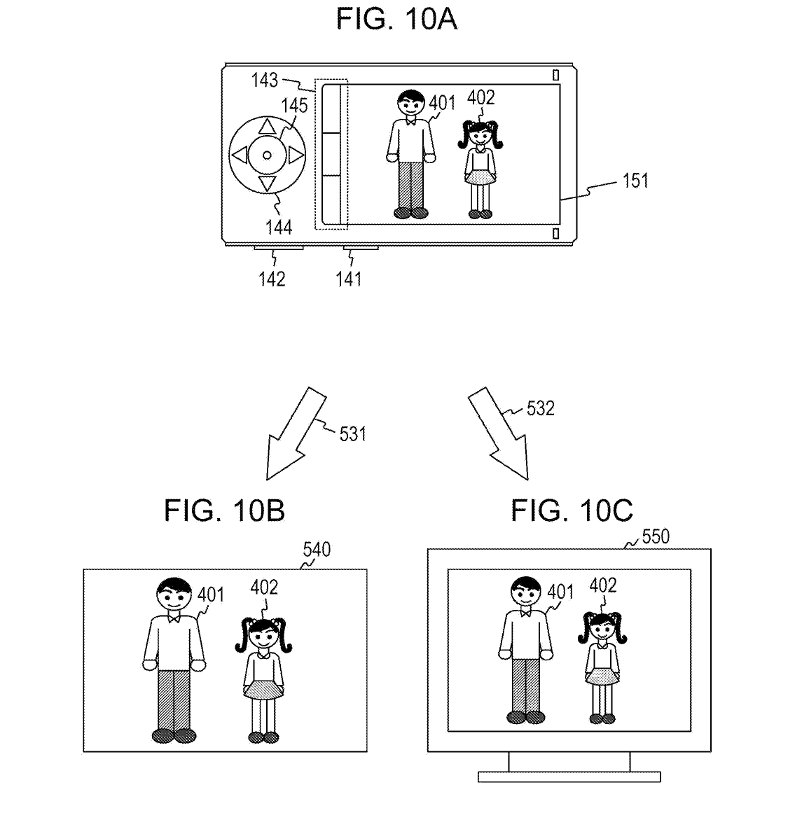

FIGS. 9A to 10C are views illustrating an example of the relationship between the posture of an image capturing device 100 and an image of which the imager conversion process has been performed by an image conversion unit 172 according to a first embodiment of the present disclosure.

FIG. 9A illustrates a display example of the input/output panel 151 in the case where the image capturing operation is performed with the image capturing device 100 in a vertical posture. The display example illustrated in FIG. 9A is equal to that in FIG. 7B.

FIG. 9B illustrates a converted image 510 that is recorded by the record control unit 175 in the case where the image capturing device 100 has the vertical posture (that is, the posture illustrated in FIG. 9A).

FIG. 9C illustrates a case where the image that is output from the communication unit 160 to the display device 520 is displayed on the display device 520 in a simplified manner in the case where the image capturing device 100 has the vertical posture (that is, the posture illustrated in FIG. 9A). In this case, it is assumed that the aspect ratio of the display surface of the display unit that is provided in the display device 520 is horizontally long.

In an example illustrated in FIG. 9A, the image capturing device 100 is shifted from the basic posture (posture illustrated in FIG. 7A) to the posture (vertical posture) that is rotated by −90° in the CCW direction. In this case, the image conversion unit 172, under the control of the control unit 174, converts the captured image by performing the aspect conversion process and the reduction process with respect to the captured image that is generated by the first image capturing unit 110. Further, under the control of the control unit 174, the record control unit 175 records the image converted by the image conversion unit 172 (converted image 510) in the storage unit 180. Further, under the control of the control unit 174, the communication unit 160 outputs the image converted by the image conversion unit 172 (converted image 510) to the external display device 520. That is, in the case of displaying the converted image 510 (illustrated in FIG. 9B) using the display device 520 having a horizontally long aspect ratio on the display surface, the converted image 510 is displayed as it is. Further, in this case, the expansion and reduction processes that correspond to the display surface of the display unit provided in the display device 520 are properly performed.

As described above, since the image (converted image 510), of which the image capturing operation has been performed in the posture illustrated in FIG. 9A (vertical posture) and which is stored in the storage unit 180, is the image that is generated by the image capturing device 100 in the vertical direction, it is displayed on the display unit 150 as a vertically long image. However, the image stored in the storage unit 180 (converted image 510) is horizontally long. Accordingly, the aspect conversion process and the reduction process are performed with respect to the image generated by the first image capturing unit 110, and a black image is added to both sides thereof in the length direction. In the reduction process, the image is reduced so that its vertical size does not exceed the size of the image to be recorded.

In the same manner, since the image, of which the image capturing operation has been performed in the posture illustrated in FIG. 9A (vertical posture) and which is displayed on the display device 520, is the image that is generated by the image capturing device 100 in the vertical posture, it is displayed on the display device 520 as the vertically long image. Even in this case, as described above, the aspect conversion process and the reduction process are performed, and a black image is added to both sides thereof in the length direction.

That is, the control unit 174 determines the posture of the image capturing device 100 on the basis of the posture information from the posture detection unit 130. Further, if it is determined that the image capturing device 100 has the vertical posture, the image conversion unit 172, under the control of the control unit 174, converts the captured image that is generated by the first capturing unit 110 and the signal processing unit 171 into an aspect converted image. Specifically, the image conversion unit 172 rotates the captured image by 90° in the CCW direction. Due to this rotation, the aspect of the captured image is converted. If the image capturing device 100 has the vertical posture, the aspect of the captured image is reversed in comparison to the basic posture, and thus by further reversing the aspect of the captured image, the aspect of the captured image can be restored to its original state.

Then, the image conversion unit 172 reduces the aspect-converted image. Here, in the first embodiment of the present disclosure, it is exemplified that the aspect ratio is set to 16:9 (=width: length) as a recording format. As described above, since the aspect ratio of the image after the aspect conversion process is 9:16 (width: length), the vertical size exceeds the size that is recordable by the recording format. Accordingly, the image is reduced so that the vertical size of the image to be recorded does not exceed the size that is recordable by the recording format. In this case, even in the case where a different aspect ratio is set (for example, 4:3 (=width: length)), the first embodiment of the present disclosure can be applied.

Then, the image conversion unit 172 adds a predetermined image (for example, the black image) to the reduced image. That is, according to the image after the reduction, the reduced image that is vertically long is included in the image having the horizontally long aspect ratio, and thus the sides of the image become open. Accordingly, the image conversion unit 172 adds a predetermined image to both sides of the image (for example, an area having a size W1 in the horizontal direction). In this image adding process, since it is preferable to fill in the image open portion, a display element except for the predetermined image (for example, image such as wallpaper) may be added instead. Through these processes, a converted image having the same size as the captured image is generated.

If the image capturing device 100 is not in the vertical posture, the control unit 174 determines not to perform the aspect conversion process and the reduction process with respect to the captured image.

FIG. 10A illustrates a display example of the input/output panel 151 in the case where the image capturing operation is performed in a state where the image capturing device 100 has a reverse posture. In this case, the display example illustrated in FIG. 10A is equal to that illustrated in FIG. 7C.

FIG. 10B illustrates a converted image 540 that is recorded by the record control unit 175 in the case where the image capturing device 100 has the reverse posture (that is, the posture illustrated in FIG. 10A).

FIG. 10C illustrates a case where the image that is output from the communication unit 160 to the display device 550 is displayed on the display device 550 in a simplified manner in the case where the image capturing device 100 has the reverse posture (that is, the posture illustrated in FIG. 10A). In this case, it is assumed that the aspect ratio of the display surface of the display unit that is provided in the display device 550 is horizontally long.

In an example illustrated in FIG. 10A, the image capturing device 100 is shifted from the basic posture (posture illustrated in FIG. 7A) to the posture (reverse posture) that is rotated by 180°. In this case, the image conversion unit 172, under the control of the control unit 174, converts the captured image by rotating the captured image that is generated by the first image capturing unit 110. Further, under the control of the control unit 174, the record control unit 175 records the image converted by the image conversion unit 172 (converted image 540) in the storage unit 180. Further, under the control of the control unit 174, the communication unit 160 outputs the image converted by the image conversion unit 172 (converted image 540) to the external display device 550. That is, in the case of displaying the converted image 540 using the display device 550 having a horizontally long aspect ratio on the display surface, the converted image 540 is displayed as it is. Further, in this case, the expansion and reduction processes that correspond to the display surface of the display unit provided in the display device 550 are properly performed.

That is, the control unit 174 determines the posture of the image capturing device 100 on the basis of the posture information from the posture detection unit 130. Further, if it is determined that the image capturing device 100 has the reverse posture, the image conversion unit 172, under the control of the control unit 174, rotates the captured image that is generated by the first capturing unit 110 and the signal processing unit 171. Specifically, the image conversion unit 172 rotates the capture image by 180°. Due to this rotation, the top and bottom of the captured image are converted. If the image capturing device 100 has the reverse posture, the top and bottom of the captured image are reversed in comparison to the basic posture, and thus by further reversing the top and bottom of the captured image, the relationship of the top and bottom of the captured image can be restored to its original state. At this time, since the captured image itself is horizontally long, the size may not be changed.

If the image capturing device 100 is not in the reverse posture, the control unit 174 determines not to rotate the captured image.

Further, if the image capturing device 100 is in the vertical posture or in the reverse posture (that is, the posture illustrated in FIG. 7B), the above-described aspect conversion process and the rotating process are performed in order.

Here, in the case where the record control unit 175 starts the recording of a moving image, the control unit 174 determines the posture of the image capturing device 100 at the start time on the basis of the posture information from the posture detection unit 130, and continues to use the result of the determination. That is, even if the image recording is continuously performed by the record control unit 175 through the moving image capturing operation, the control unit 174 controls the image conversion unit 172 on the basis of the posture of the image capturing device 100 when the record control unit 175 starts the recording of the image. For example, since the change of the posture of the image capturing device 100 after the recording of the captured image starts is often performed intentionally by a user, the above-described construction is effective. However, during the recording of the moving image through the record control unit 175, the control unit 174 may continuously determine the posture of the image capturing device 100 on the basis of the posture information from the posture detection unit 130, and sequentially control the image conversion unit 172 on the basis of the determined posture. Further, regarding the timing of such determination, the setting contents may be changed by a user operation.

Further, in the case where the converted image that is converted by the above-described processes (the aspect conversion process, the reduction process, the rotating process, and the like) is recorded in the storage unit 180 as image content, meta data (accompanying information) that indicates the converted image is included in the image content to be recorded. For example, under the control of the control unit 174, the record control unit 175 records the meta data (accompanying information) that indicates the converted image as tag information that is included in an image file. In the meta data, even the kinds of the converted images (image of which the aspect conversion process and reduction process have been performed, a rotated image, stereoscopic image, and the like) are recorded.

Here, even in the case where an image (an image to be recorded or an image to be output to the external device) is converted by the above-described processes (the aspect conversion process, the reduction process, and the rotation process, and the like), the captured image that is generated by the first image capturing unit 110 is displayed on the input/output panel 151 as a through-image. That is, since the input/output panel 151 is installed on the image capturing device 100, it is rotate together with the first image capturing unit 110. Accordingly, regardless of the posture of the image capturing device 100, since the aspect or the top and bottom are not reversed with respect to the through-image that is displayed on the input/output panel 151, it is not necessary to convert the image that is displayed on the input/output panel 151.

As described above, if the image capturing device 100 is in the vertical posture or in the reverse posture in the case where the planar image capturing mode is set, the image conversion process is performed, and thus the upper and lower direction can be accurately displayed in the displayed image. Next, a case where the image capturing device 100 is in the vertical posture or in the reverse posture in the case where the stereoscopic image capturing mode is set will be described.

[Example of Image Generation when Stereoscopic Image Capturing Mode is Set]

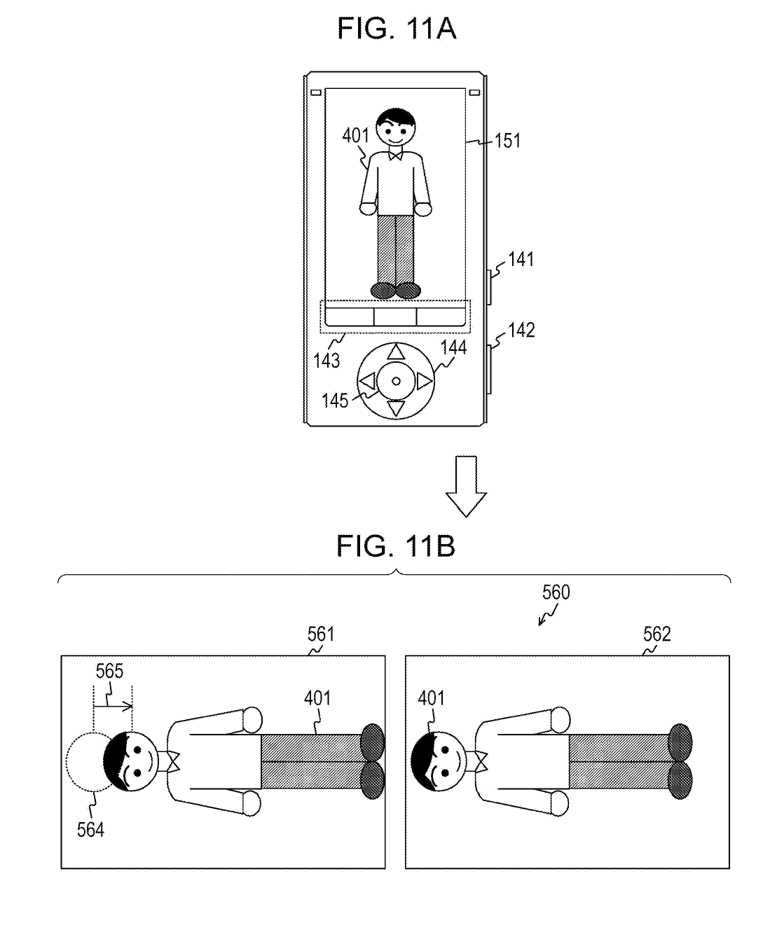

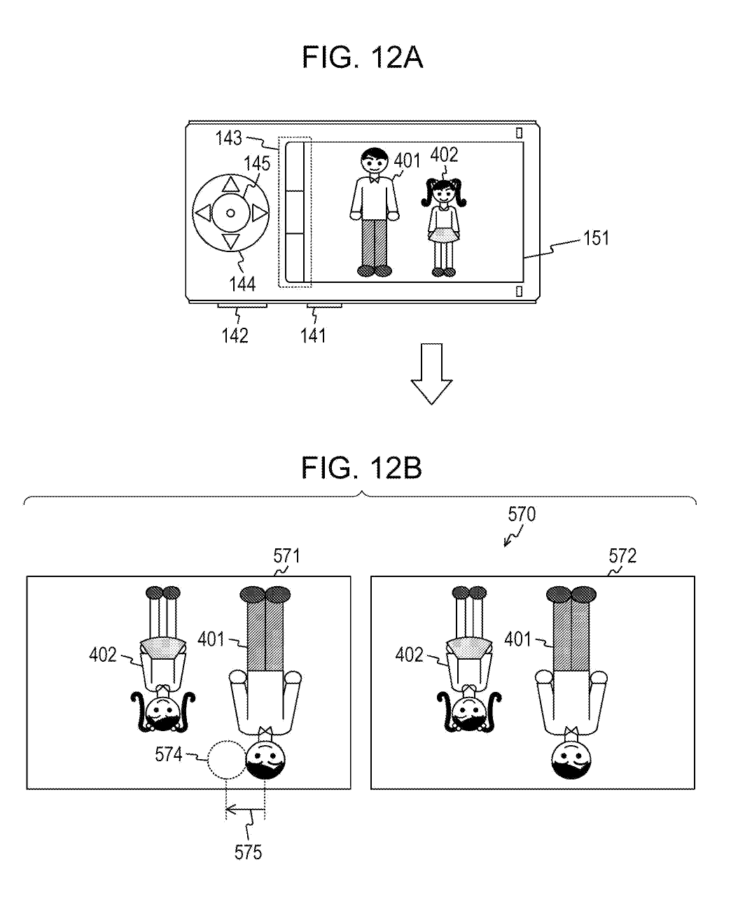

FIGS. 11A to 12B are views illustrating an example of the relationship between the posture of an image capturing device 100 during an image capturing operation and a stereoscopic image generated by an image capturing unit 190 according to a first embodiment of the present disclosure.

FIG. 11A illustrates the rear side of the image capturing device 100 during the image capturing operation that is performed in a state where the image capturing device 100 has a vertical posture in the case where a stereoscopic image capturing mode is set. That is, in an example illustrated in FIG. 11A, the display example of the input/output panel 151 in the case where the image capturing operation is performed only with respect to a person 401 as a subject.

FIG. 11B illustrates a stereoscopic image 560 that is generated when the shutter button 142 is fully pressed in a state illustrated in FIG. 11A. As described above, the stereoscopic image 560 includes a left-eye image 561 that is generated by the first image capturing unit 110 and a right-eye image 562 that is generated by the second image capturing unit 120. The left-eye image 561 and the right-eye image 562 are one set of images for displaying the stereoscopic image, and a subject (person 401) included in the image capturing range is shifted in the horizontal direction (indicated by an arrow 565). In this case, a dotted ellipse 564 indicates an outline of the face of the person 401 that is included in the right-eye image 562.

FIG. 12A illustrates the rear side of the image capturing device 100 during the image capturing operation that is performed in a state where the image capturing device 100 has a reverse posture in the case where the stereoscopic image capturing mode is set. That is, in an example illustrated in FIG. 12A, the display example of the input/output panel 151 in the case where the image capturing operation is performed with respect to persons 401 and 402 as subjects.

FIG. 12B illustrates a stereoscopic image 570 that is generated when the shutter button 142 is fully pressed in a state illustrated in FIG. 12A. As described above, the stereoscopic image 570 includes a left-eye image 571 that is generated by the first image capturing unit 110 and a right-eye image 572 that is generated by the second image capturing unit 120. The left-eye image 571 and the right-eye image 572 are one set of images for displaying the stereoscopic image, and subjects (persons 401 and 402) included in the image capturing range are shifted in the horizontal direction (indicated by an arrow 575). In this case, a dotted ellipse 574 indicates an outline of the face of the person 401 that is included in the right-eye image 572.

As illustrated in FIGS. 11B and 12B, since the stereoscopic image obtains a stereoscopic vision using parallax of left and right eyes, the subjects included in the left-eye image and the right-eye image are shifted in the horizontal direction. In the case of seeing the stereoscopic image (the left-eye image and the right-eye image) as configured above, it is necessary for a user to see the displayed stereoscopic image in predetermined position and posture. Due to this, in the case of performing the above-described image conversion process in the case where the stereoscopic image capturing mode is set, the upper and lower directions of the stereoscopic image can be accurately displayed, but the stereoscopic vision may not be obtained from the stereoscopic image. Accordingly, in the first embodiment of the present disclosure, the above-described image conversion process is not performed in the case where the stereoscopic image capturing mode is set. Accordingly, even in the case where any one image capturing mode of the planar image capturing mode and the stereoscopic image capturing mode is set, an appropriate image can be recorded.

### [Operational Example of an Image Capturing Device]

Next, the operation of the image capturing device 100 according to the first embodiment of the present disclosure will be described with reference to the accompanying drawings.

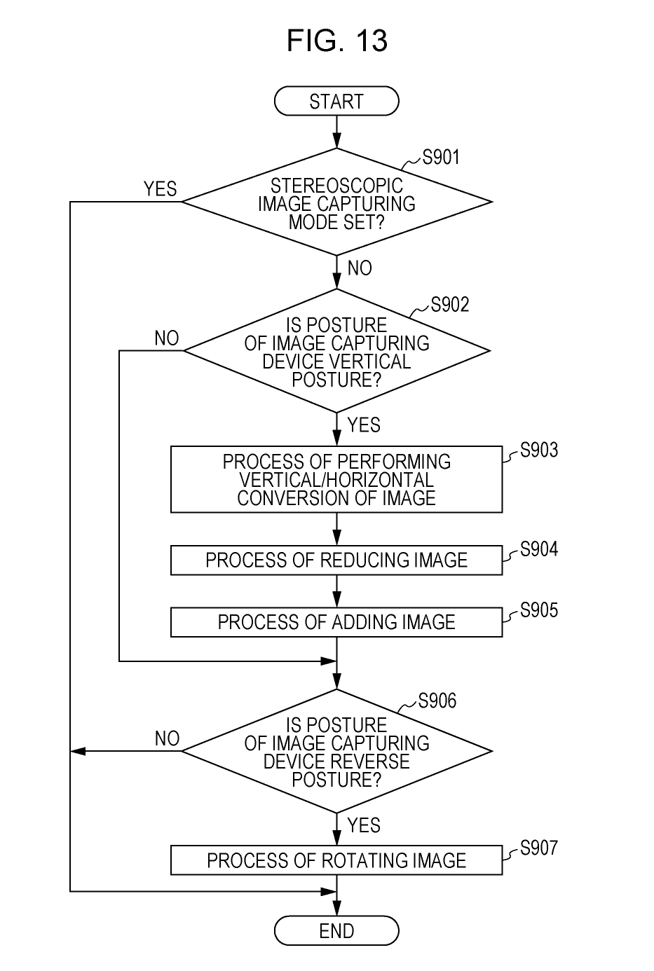

FIG. 13 is a flowchart illustrating an example of an image conversion process that is performed by the image capturing device 100 according to the first embodiment of the present disclosure. In this example, the image capturing mode is set, and an example of image conversion control process in the case where a moving image recording process is performed is shown.

First, the control unit 174 determines whether or not the stereoscopic image capturing mode is set (step S901). If the stereoscopic image capturing mode is set (step S901), the above-described image conversion process is not performed, and the operation of the image conversion control process is terminated.

Further, if the stereoscopic image capturing mode is not set (that is, if the planar image capturing mode is set) (step S901), the control unit 174 determines whether or not the image capturing device 100 has the vertical posture on the basis of the posture information from the posture detection unit 130 (step S902). If the image capturing device 100 does not have the vertical posture (step S902), the control unit 174 operates to proceed to step S906.

On the other hand, if the image capturing device 100 has the vertical posture (step S902), the image conversion unit 172, under the control of the control unit 174, performs the aspect conversion process with respect to the captured image that is output from the first image capturing unit 110 through the signal processing unit 171 (step S903). Specifically, the image conversion unit 172 performs the aspect conversion process by rotating the captured image by 90° in the CCW direction (step S903).

Then, the image conversion unit 172 performs a reduction process with respect to the image after the aspect conversion process (step S904). Then, the image conversion unit 172 performs an image adding process for adding a predetermined image (for example, a black image) to the reduced image (step S905).

Then, the control unit 174 determines whether or not the image capturing device 100 has the reverse posture on the basis of the posture information from the posture detection unit 130 (step S906). If the image capturing device 100 does not have the reverse posture (step S906), the control unit 174 terminates the operation of the image conversion control process.

On the other hand, if the image capturing device 100 has the reverse posture (step S906), the image conversion unit 172, under the control of the control unit 174, performs the rotating process with respect to the subject image (step S907). Here, the subject image is the captured image that is output from the first image capturing unit 110 through the signal processing unit 171 or the converted image that is generated by the respective image conversion processes in steps S903 to S905. Specifically, the image conversion unit 172 rotates the subject image by 180° (step S907). In addition, step S901 is an example of a determination process according to an embodiment of the present disclosure. Further, steps S902 and S906 are examples of the posture detection process according to an embodiment of the present disclosure. Further, steps S903 to S905 and S907 are examples of the control process according to an embodiment of the present disclosure.

With respect to the converted image of which the image conversion process (steps S903 to S905 and S907) has been performed or the captured image of which the image conversion process has not been performed (stereoscopic image and planar image), the record control unit 175 performs the image recording process under the control of the control unit 174. Further, in the case where the image content is recorded in the storage unit 180, as described above, meta data (accompanying information) that indicates the kind of image is included in the image content to be recorded.

Further, as described above, even in the case where the image is converted by the image conversion process, the captured image that is generated by the image capturing unit 190 is displayed on the input/output panel 151 as the through-image.

In this case, although an example of recording the image in the storage unit 180 is shown, the image that is generated by at least one of the first image capturing unit 110 and the second image capturing unit 120 may be output to an external display device in the same manner. In this case, instead of the image recording process, the communication unit 160 performs the image output process under the control of the control unit 174.

Further, in this example, the posture of the image capturing device 100 is continuously determined on the basis of the posture information from the posture detection unit 130 during the recording of the moving image through the record control unit 175 (step S902), and the image conversion unit 172 is sequentially controlled on the basis of the determined posture. However, as described above, the posture of the image capturing device 100 when the recording of the moving image starts may be determined on the basis of the posture information from the posture detection unit 130, and thereafter, the result of the determination may be continuously used.

### [Example of Image Reproduction]

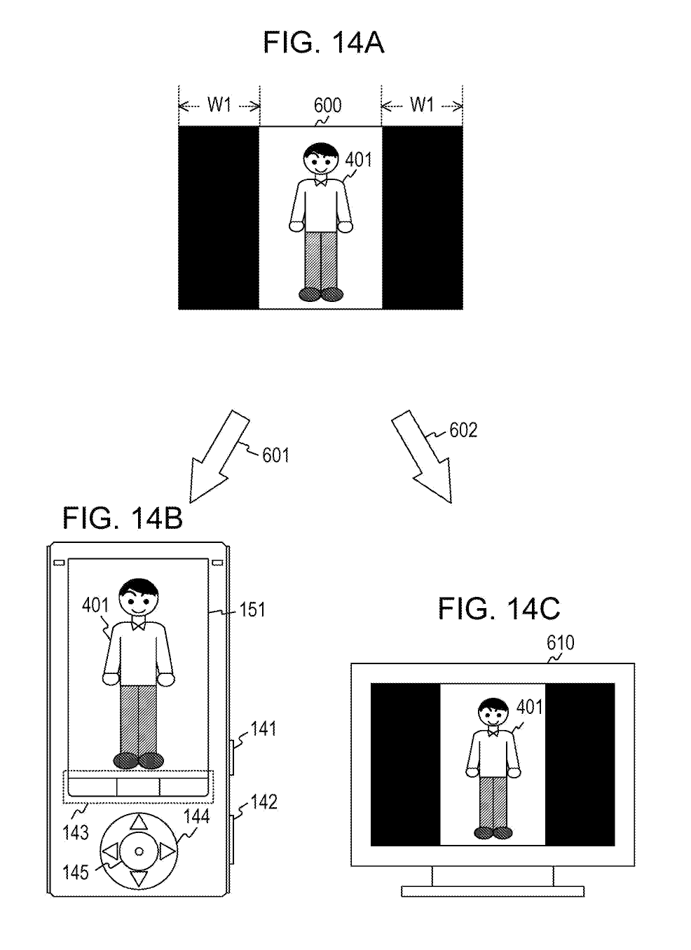

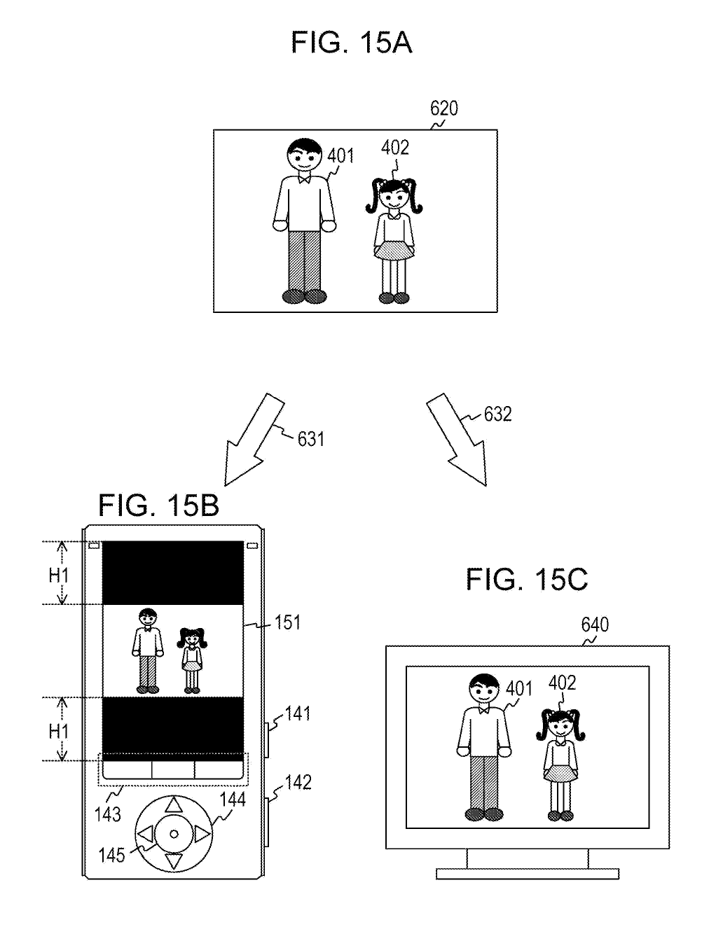

FIGS. 14A to 15C are views illustrating an example of image reproduction in the case of reproducing an image that is recorded by an image capturing device 100 according to a first embodiment of the present disclosure.

FIG. 14A illustrates the converted image 600 of which the recording process has been performed in a state where the image capturing device 100 has the vertical posture in the case where the planar image capturing mode is set. The converted image 600 is equal to the converted image 510 illustrated in FIG. 9B, and a black image (an area having a size W1) is added to both sides thereof in the horizontal direction.

FIG. 14B illustrates a display example when the converted image 600 illustrated in FIG. 14A is displayed in a state where the image capturing device 100 has the vertical posture in the case where the reproduction mode is set. In FIG. 14B, the image capturing device 100 is rotated by −90° in the CCW direction from the basic posture and has the vertical posture.

As described above, in the case where the image capturing device 100 has the vertical posture, the image to be displayed is converted to be displayed. That is, under the control of the control unit 174, the image conversion unit 172 deletes the black image from the converted image 600 that is acquired from the storage unit 180 by the display control unit 176, and enlarges the converted image 600 from which the black image has been deleted to convert the converted image 600 into a display image. Further, the display control unit 176, under the control of the control unit 174, displays the display image (the image obtained by performing the black image deletion and enlargement process with respect to the converted image 600) on the input/output panel 151 instead of the converted image 600. By displaying the converted image 600, as illustrated in FIG. 14B, the image can be displayed so that the upper and lower directions of the image that includes the person 401 coincide with the upper and lower directions of the user.

That is, in the case where the image capturing device 100 has the vertical posture and the aspect ratio on the display surface of the input/output panel 151 is vertically long, the converted image is enlarged from the reduced size to the size during the image capturing to be displayed.

FIG. 14C illustrates a display example in the case of displaying the converted image 600 (illustrated in FIG. 14A) using the display device 610. In this case, it is assumed that the aspect ratio on the display surface of the display unit that is provided in the display device 610 is horizontally long. As described above, in the case of displaying the converted image 600 (illustrated in FIG. 14A) using the display device 610 having the horizontally long aspect ratio on the display surface, the black image is not deleted from the converted image 600, and the converted image 600 is displayed as it is. Further, in this case, the enlargement or reduction process that corresponds to the display surface of the display unit provided in the display device 610 is appropriately performed.

FIG. 15A illustrates the planar image 620 of which the recording process has been performed in a state where the image capturing device 100 has the basic posture in the case where the planar image capturing mode is set. The planar image 620 is equal to the planar image 430 illustrated in FIG. 6B (that is, the planar image 620 is not the converted image).

FIG. 15B illustrates the display example when the planar image 620 illustrated in FIG. 15A is displayed in a state where the image capturing device 100 has the vertical posture in the case where the reproduction mode is set. In FIG. 15B, the image capturing device 100 is rotated by −90° in the CCW direction from the basic posture and has the vertical posture.

As described above, if the image to be displayed is not the converted image and the image capturing device 100 has the vertical posture, the image to be displayed is converted to be displayed. That is, under the control of the control unit 174, the image conversion unit 172 reduces the planar image 620 that is acquired from the storage unit 180 by rotating the image by 90° in the CCW direction by the display control unit 176, and converts the planar image into a display image by adding a predetermined image (for example the black image) to the planar image. This reduction process, for example, is performed so that the horizontal size of the planar image 620 becomes the displayable size on the display surface of the input/output panel 151.

Further, the display control unit 176, under the control of the control unit 174, displays the display image (the image obtained by performing the rotation and reduction of the planar image 620 and the black image addition) on the input/output panel 151 instead of the planar image 620. By displaying the planar image 620, as illustrated in FIG. 15B, the image can be displayed so that the upper and lower directions of the image that includes the persons 401 and 402 coincide with the upper and lower directions of the user.

That is, in the case where the image capturing device 100 has the vertical posture and the aspect ratio on the display surface of the input/output panel 151 is vertically long, the planar image (horizontally long aspect ratio) is displayed after the rotation, reduction and black image addition processes are performed with respect to the planar image.

FIG. 15C illustrates a display example in the case of displaying the planar image 620 (illustrated in FIG. 15A) using the display device 640. In this case, it is assumed that the aspect ratio on the display surface of the display unit that is provided in the display device 640 is horizontally long. As described above, in the case of displaying the planar image 600 using the display device 640 having the horizontally long aspect ratio on the display surface, the planar image 620 is displayed as it is. In this case, the enlargement or reduction process that corresponds to the display surface of the display unit provided in the display device 640 is appropriately performed.

Here, it is assumed that the image capturing device 100 has a reverse posture, or the vertical posture and the reverse posture in the case of displaying the converted image 600 (illustrated in FIG. 14A) or the planar image 620 (illustrated in FIG. 15A). In this case, even in the case of performing the above-described processes, the upper and lower directions of the displayed image and the upper and lower directions of the user are reversed. Accordingly, in the case where the image capturing device 100 has the reverse posture or the vertical posture and the reverse posture, the image to be displayed is converted through rotation to be displayed. That is, under the control of the control unit 174, the image conversion unit 172 rotates the image to be displayed, of which the above-described processes have been performed, by 180°. Through this rotation, the upper and lower directions of the image to be displayed, of which the above-described processes have been performed, can be reversed.

As described above, in the case where the image capturing device 100 has the vertical posture or the reverse posture, the upper and lower directions of the display image can be surely displayed through performing of the image conversion process.

Here, it is assumed that the image to be displayed is the stereoscopic image in the case where the reproduction mode is set. As described above, in the case of seeing the stereoscopic image (the left-eye image and the right-eye image), it is necessary for a user to see the displayed stereoscopic image in predetermined position and posture. Due to this, in the case of performing the above-described image conversion process in the case where the reproduction mode is set, the upper and lower directions of the stereoscopic image can be accurately displayed, but the stereoscopic vision may not be obtained from the stereoscopic image. Accordingly, in the first embodiment of the present disclosure, if the image to be displayed is the stereoscopic image in the case where the reproduction mode is set, the above-described image conversion process is not performed. Accordingly, even if the stereoscopic image is displayed in the case where the reproduction mode is set, an appropriate image can be displayed.

### [Operational Example of an Image Capturing Device]

Next, the operation of the image capturing device 100 according to the first embodiment of the present disclosure will be described with reference to the accompanying drawings.

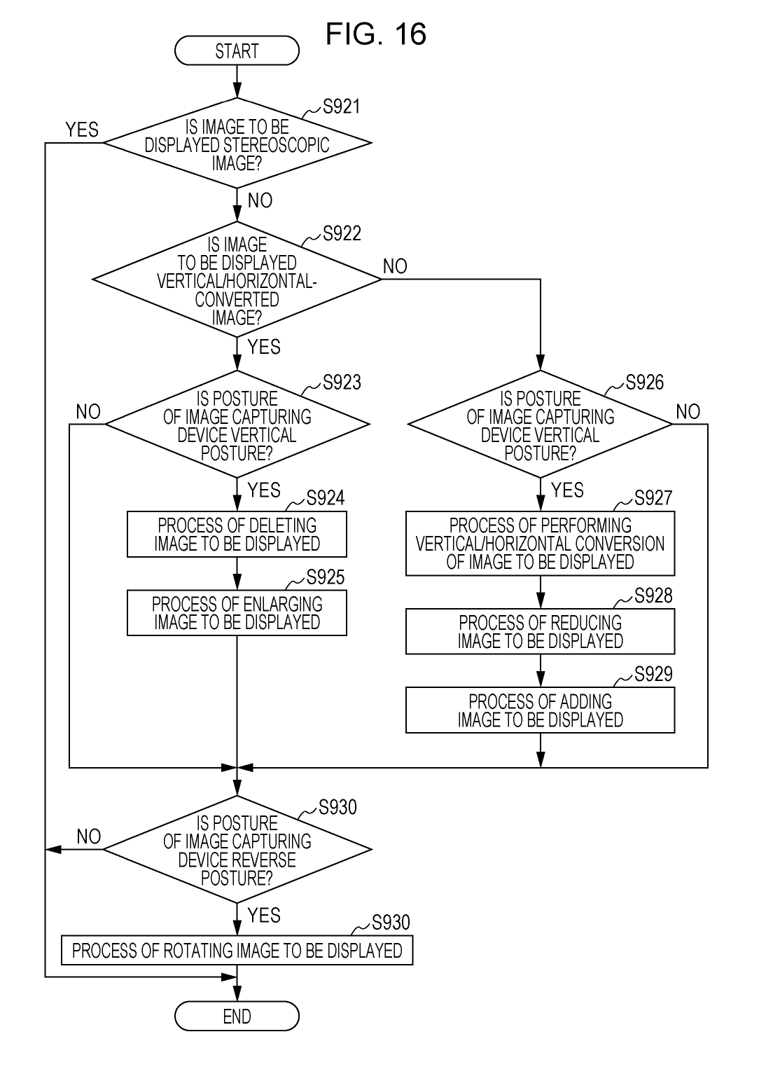

FIG. 16 is a flowchart illustrating an example of an image conversion process that is performed by the image capturing device 100 according to the first embodiment of the present disclosure. In this example, an example of image conversion control process in the case of displaying the image recorded by the image capturing device 100 (planar image (including the aspect-converted image and the reversed image) or the stereoscopic image) is shown. Further, in this example, an example of the image conversion control process in the case where the display process is performed with respect to the image that is acquired by the display control unit 176 on the basis of the user operation is shown.

First, the control unit 174 determines whether or not the image to be displayed is the stereoscopic image (step S921). For example, whether or not the image to be displayed is the stereoscopic image is determined on the basis of the meta data included in the image content (accompanying information (for example, tag information included in the image file)). If the image to be displayed is the stereoscopic image (step S921), the operation of the image conversion control process is terminated. At this time, if the image to be displayed is the stereoscopic image (step S921), the control unit 174 determines whether or not the image to be displayed is the aspect-converted image (step S922). For example, whether or not the image to be displayed is the aspect conversion image is determined on the basis of the meta data included in the image content (accompanying information (for example, tag information included in the image file)).

If the image to be displayed is the aspect-converted image (step S922), the control unit 174 determines whether or not the image capturing device 100 has the vertical posture on the basis of the posture information from the posture detection unit 130 (step S923). If the image capturing device 100 does not have the vertical posture (step S923), the control unit 174 operates to proceed to step S930. In this case, if the image capturing device 100 has the vertical posture (step S923), the image conversion unit 172, under the control of the control unit 174, performs the image conversion process with respect to the image (image content) to be displayed that the display control unit 176 acquires from the storage unit 180 (steps S924 and S925). That is, the image conversion unit 172 deletes the predetermined image (for example, black image) that is added on both sides in the horizontal direction of the aspect-converted image (image to be displayed) (step S924). Then, the image conversion unit 172 performs the enlargement process with respect to the aspect-converted image from which the black image has been deleted (step S925). For example, the enlargement process is performed so that the size of the aspect-converted image, from which the black image has been deleted, fits the size of the display surface of the display unit 150.

If the image to be displayed is not the aspect-converted image (step S922), the control unit 174 determines whether or not the image capturing device 100 has the vertical posture on the basis of the posture information from the posture detection unit 130 (step S926). If the image capturing device 100 does not have the vertical posture (step S926), the control unit 174 operates to proceed to step S930.

Further, if the image capturing device 100 has the vertical posture (step S926), the image conversion unit 172, under the control of the control unit 174, performs the image conversion process (steps S927 to S929). That is, the image conversion unit 172, under the control of the control unit 174, performs the aspect conversion process (rotation by 90° in the CCW direction) with respect to the image (image content) to be displayed that is acquired from the storage unit 180 by the display control unit 176 (step S927). Then, the image conversion unit 172 performs the reduction process with respect to the aspect-converted image to be displayed (step S928). For example, the reduction process is performed so that the size of the image to be displayed in the horizontal direction does not exceed the size of the display surface of the display unit 150 (step S928). Then, the image conversion unit 172 performs the image adding process for adding a predetermined image (for example, black image) to both sides of the image to be displayed in the vertical direction (step S929). That is, as illustrated in FIG. 15B, in the case where the image of which the reduction process has been performed is displayed on the input/output panel 151 that is in a vertical state, the image to be displayed is displayed in a reduced horizontal state, and thus the sides of the image to be displayed become open. Accordingly, the image conversion unit 172 adds the predetermined image to both sides of the image to be displayed (for example, black image). In this case, instead of adding the black image, a display element except for the black image (for example, image such as wallpaper) may be added.

Then, the control unit 174 determines whether or not the image capturing device 100 has the reverse posture on the basis of the posture information from the posture detection unit 130 (step S930). If the image capturing device 100 does not have the reverse posture (step S930), the operation of the image conversion control process is terminated. If the image capturing device 100 has the reverse posture (step S930), the image conversion unit 172, under the control of the control unit 174, performs the rotating process with respect to the image to be displayed (step S931). That is, the image conversion unit 172 rotates the image to be displayed by 180° (step S931). The image to be displayed includes the image of which the image process has been performed in steps S924, S925, S927 to S929. Through this rotating process, the upper and lower portions of the image to be displayed are reversed. That is, if the image to be displayed is displayed on the input/output panel 151 as it is in the case where the image capturing device 100 has the reverse posture, the upper and lower portions of the image to be displayed are reversed, and thus the upper and lower portions of the image can be accurately displayed on the input/output panel 151.

Further, in this example, the posture of the image capturing device 100 is continuously determined on the basis of the posture information from the posture detection unit 130 during the display process through the display control unit 176 (step S922), and the image conversion unit 172 is sequentially controlled on the basis of the determined posture. However, the posture of the image capturing device 100 when the recording of the moving image starts may be determined on the basis of the posture information from the posture detection unit 130, and thereafter, the result of the determination may be continuously used.

In this example, the image is displayed on the display unit 150. Here, in the case where the image that is stored in the storage unit 180 is output to the external display device, the above-described image conversion process is not performed. That is, since it is assumed that the external display device has a constant posture regardless of the posture of the image capturing device 100, the aspect or upper and lower portions are not reversed between the image to be displayed and the image that is displayed on the external display device regardless of the posture of the image capturing device 100. Accordingly, it is not necessary to perform the above-described image conversion process.

As described above, in the first embodiment of the present disclosure, even in the case where the image capturing device 100 during the image capturing has the vertical posture or the reverse posture when the planar image capturing mode is set, the image, in which the upper and lower portions of the subject and the upper and lower portions of the user coincide with each other, can be recorded. However, the image that is generated by the image capturing unit 190 is displayed on the input/output panel 151 of the image capturing device 100 as the through-image. Accordingly, the through-image, in which the upper and lower portions of the subject and the upper and lower portions of the user coincide with each other, can be displayed.

Further, in the case of displaying the planar image when the reproduction mode is set, the image, in which the upper and lower portions of the subject and the upper and lower portions of the user coincide with each other, can be displayed even if the image capturing device 100 has the vertical posture or the reverse posture.

Further, the posture of the external display device is not influenced by the posture of the image capturing device 100. Accordingly, in the case of outputting the image to the external display device, the image, in which the upper and lower portions of the subject and the upper and lower portions of the user coincide with each other, can be displayed without performing the above-described image conversion process.

Further, in the first embodiment of the present disclosure, when the stereoscopic image capturing mode is set, the above-described image conversion process is not performed. Accordingly, the image content, in which the stereoscopic vision can be obtained from the stereoscopic image, can be appropriately recorded. That is, even in the case where any one image capturing mode of the planar image capturing mode and the stereoscopic image capturing mode is set, the image process can be appropriately performed according to the image capturing mode, and an appropriate image can be recorded. Further, if the image to be displayed is the stereoscopic image (stereoscopic image content) in the case where the reproduction mode is set, the above-described image conversion process is not performed. Accordingly, the stereoscopic vision can be appropriately obtained from the displayed stereoscopic image. That is, even with respect to the image content that is recorded in any one image capturing mode of the planar image capturing mode and the stereoscopic image capturing mode, an appropriate image process can be performed according to the image capturing mode, and an appropriate image can be displayed.

In the first embodiment of the present disclosure, it is exemplified that the image (image data) generated by the image capturing unit 190 is stored in the storage unit 180 of the image capturing device 100. However, for example, even with respect to the case where the image (image data) is stored in the external storage device through the communication unit 160, the first embodiment of the present disclosure can be applied.

Further, in the first embodiment of the present disclosure, it is exemplified that the image (image data) is read from the storage unit 180 of the image capturing device 100 during the reproduction. However, for example, even with respect to the case where the image (image data) is read from the external storage unit through the communication unit 160 and the read image becomes the image to be displayed, the first embodiment of the present disclosure can be applied.

Further, in the first embodiment of the present disclosure, it is exemplified that the kind of the image is determined by the meta data that is added to the image content. However, for example, the meta data may be recorded in a property file that is separately prepared in the storage unit 180 and the kind of the image may be determined using the metal data.

### 2. Modifications

In the first embodiment of the present disclosure, it is exemplified that the image capturing device (so-called two-eye type 3D camera) has two image capturing units. However, even with respect to the image capturing device that can generates a stereoscopic image and a planar image through one image capturing unit (so-called one-eye type 3D camera), the first embodiment of the present disclosure can be applied.

Further, in an embodiment of the present disclosure, an image capturing device is exemplified as an example of the image processing apparatus. However, the embodiment of the present disclosure can be applied to a portable phone that can treat various kind of images (plane image, stereoscopic image, and the like), a navigation system, an image processing device (for example, an electronic appliance having a photographing function) such as a portable media player or the like.

The embodiment of the present disclosure shows an example for realizing the present disclosure, and as clearly indicated by the embodiment of the present disclosure, items in the embodiment of the present disclosure and specified items in claims correspond to each other. In the same manner, specified items in claims and items in the embodiment of the present disclosure having the same names correspond to each other. However, the present disclosure is not limited to the embodiment, and diverse modifications may be made without departing from the scope of the present disclosure.

Further, the processes as described in the embodiment of the present disclosure may be grasped as a method having these series of processed, and may be grasped as a program for making a computer execute these series of processes, or a recording medium storing the program. As the recording medium, a CD (Compact Disc), an MD (MiniDisc), a DVD (Digital Versatile Disk), a memory card, a Blu-ray disc (registered trademark), and the like, may be used.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a posture detection unit detecting a posture of the image processing apparatus;
an image capturing unit capturing a subject and generating a planar image that includes the subject or a stereoscopic image for stereoscopy of the subject;
a mode setting unit setting any one of a planar image capturing mode for recording the planar image and a stereoscopic image capturing mode for recording the stereoscopic image on the basis of user operation;
an image conversion unit converting the image that is generated by the image capturing unit through performing of an aspect conversion process and a reduction process with respect to the image; and
a control unit operating to record the stereoscopic image on a recording medium regardless of the detected posture of the image processing apparatus if the stereoscopic image capturing mode is set and to record any one of the planar image and a converted image that is an image obtained by converting the planar image through the image conversion unit on the recording medium on the basis of the detected posture of the image processing apparatus if the planar image capturing mode is set.

2. The image processing apparatus according to claim 1, wherein the control unit operates to record the planar image on the recording medium if a first posture that is a posture in which a length direction and a horizontal direction of a housing of the image processing apparatus coincide with each other is detected, while to record the converted image on the recording medium if a second posture that is a posture in which the length direction and a vertical direction of the housing coincide with each other is detected in the case where the planar image capturing mode is set.

3. The image processing apparatus according to claim 2, wherein the image conversion unit converts the image through rotating of the planar image or the converted image by 180°, and
the control unit operates to record the image obtained through rotating of the planar image through the image conversion unit on the recording medium if a reverse posture that is a posture in which upper and lower directions of the housing of the image processing apparatus are reversed on the basis of the first posture is detected in the case where the planar image capturing mode is set, while to record the image obtained through rotating of the converted image through the image conversion unit on the recording medium if the reverse posture that is a posture in which upper and lower directions of the housing of the image processing apparatus are reversed on the basis of the second posture is detected in the case where the planar image capturing mode is set.

4. The image processing apparatus according to claim 1, wherein the image capturing unit includes a first image capturing unit generating a first image for displaying the stereoscopic image and a second image capturing unit generating a second image for displaying the stereoscopic image, and
the control unit operates to record the first image and the second image on the recording medium as the stereoscopic image if the stereoscopic image capturing mode is set, while to record any one of the first image and the converted image that is the image obtained by converting the first image through the image conversion unit on the recording medium if the planar image capturing mode is set.

5. The image processing apparatus according to claim 1, wherein the image capturing unit generates a moving image that is formed by the planar image or a moving image that is formed by the stereoscopic image, and further includes an operation reception unit receiving an instruction operation of recording operation start of the moving image, and
the control unit determines whether to record any one of the planar image and the converted image on the recording medium as a moving image that is related to the instruction operation on the basis of the posture of the image processing apparatus that is detected when the instruction operation is received in the case where the planar image capturing mode is set.

6. The image processing apparatus according to claim 1, wherein the mode setting unit sets a reproduction mode for displaying any one of the planar image that is recorded on the recording medium, the converted image, and the stereoscopic image on the display unit on the basis of the user operation,
the image conversion unit converts the image that is recorded on the recording medium through performing of the aspect conversion process and an enlargement process with respect to the corresponding image, and
the control unit controls the display unit to display the stereoscopic image regardless of the detected posture of the image processing apparatus if the image to be displayed is the stereoscopic image in the case where the reproduction mode is set, and controls the display unit to display any one of the planar image, the converted image, and an image that is newly converted by the image conversion unit on the basis of the detected posture of the image processing apparatus and whether or not the image to be displayed is the converted image if the image to be displayed is not the stereoscopic image.

7. An image processing apparatus comprising:
a posture detection unit detecting a posture of the image processing apparatus;
an image capturing unit capturing a subject and generating a planar image that includes the subject or a stereoscopic image for stereoscopy of the subject;
a mode setting unit setting any one of a planar image capturing mode for recording the planar image and a stereoscopic image capturing mode for recording the stereoscopic image on the basis of user operation;
an image conversion unit converting the image that is generated by the image capturing unit through performing of an aspect conversion process and a reduction process with respect to the image; and
a control unit operating to transmit stereoscopic image information for displaying the stereoscopic image to a display device regardless of the detected posture of the image processing apparatus if the stereoscopic image capturing mode is set and to transmit image information for displaying any one image of the planar image and a converted image that is an image obtained by converting the planar image through the image conversion unit to the display device on the basis of the detected posture of the image processing apparatus if the planar image capturing mode is set.

8. An image processing apparatus comprising:
a posture detection unit detecting a posture of the image processing apparatus;
an image conversion unit converting an image to be displayed through performing of an aspect conversion process and an enlargement process with respect to the image to be displayed in the case where a reproduction mode for making a display unit display a planar image that includes a subject to be captured, a converted image that is obtained by performing the aspect conversion process and a reduction process with respect to the planar image, and the image to be displayed which is acquired from a recording medium that records a stereoscopic image for stereoscopy of the subject is set; and
a control unit controlling the display unit to display the stereoscopic image regardless of the detected posture of the image processing apparatus if the image to be displayed is the stereoscopic image in the case where the reproduction mode is set, and controlling the display unit to display any one of the planar image, the converted image, and an image that is newly converted by the image conversion unit on the basis of the detected posture of the image processing apparatus and whether or not the image to be displayed is the converted image if the image to be displayed is not the stereoscopic image.

9. A method of controlling an image processing apparatus comprising:
detecting a posture of the image processing apparatus having an image capturing unit capturing a subject and generating a planar image that includes the subject or a stereoscopic image for stereoscopy of the subject;
determining if any one image capturing mode of a planar image capturing mode for recording the planar image and a stereoscopic image capturing mode for recording the stereoscopic image is set; and
performing a control to record the stereoscopic image on a recording medium regardless of the detected posture of the image processing apparatus if the stereoscopic image capturing mode is set and to record any one of the planar image and a converted image that is an image obtained by converting the planar image through performing of an aspect conversion process and a reduction process through an image conversion unit on the recording medium on the basis of the detected posture of the image processing apparatus if the planar image capturing mode is set.

10. A program causing a computer to execute:
detecting a posture of the image processing apparatus having an image capturing unit capturing a subject and generating a planar image that includes the subject or a stereoscopic image for stereoscopy of the subject;
determining if any one image capturing mode of a planar image capturing mode for recording the planar image and a stereoscopic image capturing mode for recording the stereoscopic image is set; and
performing a control to record the stereoscopic image on a recording medium regardless of the detected posture of the image processing apparatus if the stereoscopic image capturing mode is set and to record any one of the planar image and a converted image that is an image obtained by converting the planar image through performing of an aspect conversion process and a reduction process through an image conversion unit on the recording medium on the basis of the detected posture of the image processing apparatus if the planar image capturing mode is set.
